(19) United States
(12) Patent Application Publication
(10) Pub. No.: US 2016/0259102 A1
(43) Pub. Date: Sep. 8, 2016

(54) LIGHT-REFLECTING FILM AND LIGHT REFLECTOR USING THE SAME

(71) Applicant: KONICA MINOLTA, INC., Tokyo (JP)

(72) Inventor: Yukako TAKA, Inagi-shi, Tokyo (JP)

(21) Appl. No.: 15/036,952

(22) PCT Filed: Dec. 12, 2014
(86) PCT No.: PCT/JP2014/083038

§ 371 Date: May 16, 2016

(30) Foreign Application Priority Data
Dec. 18, 2013 (JP) 2013-261319

(51) Int. Cl. G02B 5/20; B32B 27/18; B32B 7/02; G02B 1/04; B32B 27/36; G02B 5/08; G02B 5/26; B32B 27/08; B32B 27/30

(52) U.S. Cl. CPC G02B 5/208; B32B 27/08; B32B 27/18; B32B 7/02; B32B 27/308; B32B 27/306; B32B 27/36; G02B 5/08; G02B 5/26; G02B 1/04; B32B 2307/416; B32B 2307/418; B32B 2605/006; B32B 2255/10; B32B 2255/24

(57) ABSTRACT

To provide a light-reflecting film that, while ensuring tight adhesiveness to an adherend having a curved surface, leaves little adhesive residue when peeled from an adherend for the purposes of re-attaching, can be re-attached, and is excellent in durability and heat ray-shielding conductance.

A light-reflecting film including: a reflective layer having at least one or more laminate(s) in which a high refractive index layer containing a polymer and a low refractive index layer containing a polymer are laminated; a pressure-sensitive adhesive layer that is disposed on one outermost layer; and a hard coat layer that is disposed on another outermost layer, wherein the elastic modulus of the pressure-sensitive adhesive layer and the elastic modulus of the hard coat layer satisfy the following Formula (1): the elastic modulus of the hard coat layer [Pa]/the elastic modulus of the pressure-sensitive adhesive layer [Pa]≧3, and the instantaneous pressure-sensitive adhesive force exhibited when the pressure-sensitive adhesive layer is applied to glass is from 2 to 8 N/25 mm.

### TECHNICAL FIELD

The present invention relates to a light-reflecting film and a light reflector using this light-reflecting film.

### BACKGROUND ART

Recently, interest in energy saving measures have been increased, and thus near-infrared ray-reflecting films that block transmission of heat rays in sunlight from window glasses of buildings and vehicles have been actively developed. This is because the infrared ray-reflecting films can decrease the load on cooling equipment, and thus are effective as a countermeasure for energy saving.

In recent years, it was theoretically supported that a laminate film formed by alternately laminating high refractive index layers and low refractive index layers selectively reflects light at a specific wavelength as a near infrared ray-reflecting film (JP 2002-509279 W).

Furthermore, JP 2011-183742 A discloses a laminate film for window labelling including a plastic film layer, and a silicone rubber layer having a surface to be stuck on a window, and describes that the above-mentioned laminate film for window labelling can be easily attached and peeled, and is excellent in weather resistance.

On the other hand, JP 2013-80221 A describes that a heat ray shielding material having a metal particle-containing layer (i.e., a heat ray shielding layer) containing at least one kind of metal particles (i.e., a heat ray shielding layer) and a pressure-sensitive adhesive layer has a high heat ray-shielding conductance (sunshine reflectance), is excellent in heat ray-shielding durability when attached to glass, is easily re-attached to an adherend, and has fine pressure-sensitive adhesive force on an adherend.

### SUMMARY OF INVENTION

Under such circumstance, the present inventors adopted the constitutions described in JP 2011-183742 A and JP 2013-80221 A to the laminate film using a high refractive index layer and a low refractive index layer described in JP 2002-509279 W and tried to use the laminate film as a light-reflecting film for shielding the permeation of heat ray, the light-reflecting film (infrared ray-shielding film) was not be able to ensure the tight adhesiveness between the film and an adherend when attached to, for example, a curved surface of glass, and further caused a problem that, when the film was peeled from the adherend for the purpose of re-attaching of the film, adhesive residue occurred, and thus the tight adhesiveness was bad and the film peeled when the film was attached again.

The present invention has been made with consideration for the above-mentioned situation, and an object thereof is to provide a light-reflecting film that, while ensuring tight adhesiveness to an adherend having a curved surface, leaves little adhesive residue when peeled from an adherend for the purposes of re-attaching, can be re-attached, and is excellent in durability and heat ray-shielding conductance.

The present inventors did intensive studies so as to solve the above-mentioned problem.

Consequently, the present inventors found that the above-mentioned problem can be solved by a light-reflecting film, including: a reflective layer having at least one or more laminate(s) in which a high refractive index layer containing a polymer and a low refractive index layer containing a polymer are laminated, a pressure-sensitive adhesive layer that is disposed on one outermost layer, and a hard coat layer that is disposed on another outermost layer, wherein the ratio of the elastic modulus of the pressure-sensitive adhesive layer and the elastic modulus of the hard coat layer satisfies a predetermined value, and the instantaneous pressure-sensitive adhesive force exhibited when the pressure-sensitive adhesive layer is applied to glass also satisfies a predetermined value.

Specifically, the above-mentioned object of the present invention is achieved by the following constitutions.

1. A light-reflecting film including: a reflective layer having at least one or more laminate(s) in which a high refractive index layer containing a polymer and a low refractive index layer containing a polymer are laminated; a pressure-sensitive adhesive layer that is disposed on one outermost layer; and a hard coat layer that is disposed on another outermost layer, wherein the elastic modulus of the pressure-sensitive adhesive layer and the elastic modulus of the hard coat layer satisfy the following Formula (1): the elastic modulus of the hard coat layer [Pa]/the elastic modulus of the pressure-sensitive adhesive layer [Pa]≧3, and the instantaneous pressure-sensitive adhesive force exhibited when the pressure-sensitive adhesive layer is applied to glass is from 2 to 8 N/25 mm.

2. The light-reflecting film according to the above 1, wherein the instantaneous pressure-sensitive adhesive force exhibited when the pressure-sensitive adhesive layer is applied to the glass is from 4 to 8 N/25 mm, and the pressure-sensitive adhesive force over time when the pressure-sensitive adhesive layer and the glass are left with keeping the attached state under conditions of 30° C. and a humidity of 60% RH for 1 week is from 7 to 15 N/25 mm.

3. The light-reflecting film according to the above 2, wherein the pressure-sensitive adhesive force over time is from 10 to 15 N/25 mm

4. The light-reflecting film according to any one of the above 1 to 3, wherein the polymer contained in the high refractive index layer and the low refractive index layer contains at least one kind selected from the group consisting of polyesters, polycarbonates and poly(meth)acrylates.

5. The light-reflecting film according to any one of the above 1 to 4, wherein the polymer contained in the high refractive index layer and the low refractive index layer contains at least one kind of polyvinyl alcohol-based resins.

6. The light-reflecting film according to any one of the above 1 to 5, which contains heat ray-shielding microparticles.

7. A light reflector including a light-permeable substrate, and the light-reflecting film according to any one of the above 1 to 6 attached to the light-permeable substrate.

8. The light reflector according to the above 7, wherein the light-permeable substrate has a curved surface.

### BRIEF DESCRIPTION OF DRAWINGS

FIG. 1 is a schematic cross-sectional view showing a general constitution of a light-reflecting film (an infrared ray-shielding film) used in an embodiment of the present invention.

FIG. 2 is a schematic cross-sectional view showing a general constitution of a light-reflecting film (infrared ray-shielding film) used in another embodiment of the present invention.

### DESCRIPTION OF EMBODIMENTS

A light-reflecting film according to the present embodiment includes: a reflective layer having at least one or more laminate(s) in which a high refractive index layer containing a polymer and a low refractive index layer containing a polymer are laminated; a pressure-sensitive adhesive layer that is disposed on one outermost layer; and a hard coat layer that is disposed on another outermost layer, wherein the elastic modulus of the pressure-sensitive adhesive layer and the elastic modulus of the hard coat layer satisfy the following Formula (1): the elastic modulus of the hard coat layer [Pa]/the elastic modulus of the pressure-sensitive adhesive layer [Pa]≧3, and the instantaneous pressure-sensitive adhesive force exhibited when the pressure-sensitive adhesive layer is applied to glass is from 2 to 8 N/25 mm. According to the present invention having such constitution, a light-reflecting film that, while ensuring tight adhesiveness to an adherend (specifically an adherend having a curved surface), leaves little adhesive residue when peeled from an adherend for the purposes of re-attaching, can be re-attached, and is excellent in durability and heat ray-shielding conductance can be provided.

The exemplary embodiments of the present invention will be explained below with referring to the attached drawings. In the explanation of the drawings, an identical symbol is attached to identical elements, and overlapping explanation is abbreviated. Furthermore, some dimensional ratios in the drawings are exaggerated for the convenience of explanation and are different from the actual ratios.

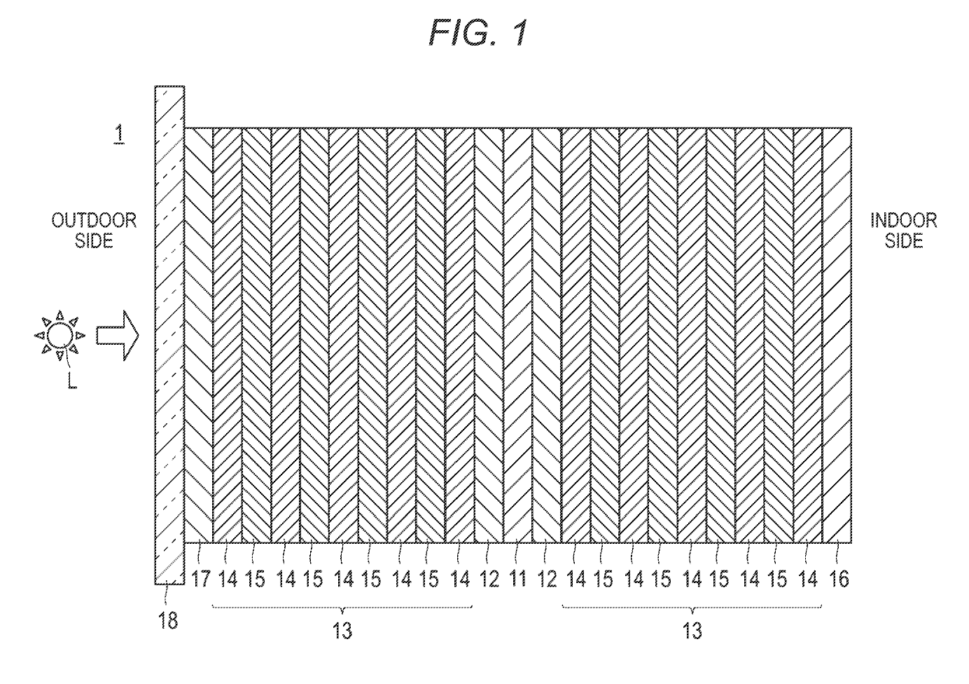

FIG. 1 is a schematic cross-sectional view showing a general constitution of a light-reflecting film (an infrared ray-shielding film) used in an embodiment of the present invention.

As shown in FIG. 1, the light-reflecting film 1 of this embodiment has a substrate 11, primer layers 12 formed on the both surfaces of the substrate 11, and reflective layers 13 that are formed on the primer layers 12 on the both surfaces of the substrate 11. Each of the reflective layers 13 formed on the both surfaces of the substrate 11 is constituted so as to have at least one or more laminate(s) formed by laminating a low refractive index layer 14 and a high refractive index layer 15 (the laminate refers to a structure formed of two layers in which one low refractive index layer 14 and one high refractive index layer 15 are laminated). Furthermore, specifically, in this embodiment shown in FIG. 1, the constitution is formed of 4.5 laminate bodies, in which nine-layered multilayer articles (reflective layers 13), in which five low refractive index layers 14 and four high refractive index layers 15 are alternately laminated, are respectively formed on the both surfaces of the substrate 11 so that the low refractive index layers 14 are disposed on the lowermost layer on the substrate side and on the uppermost layer. In this embodiment, a transparent hard coat layer (a HC layer) 16 is formed on the low refractive index layer 14 on the uppermost layer of the nine-layer multilayer article (the reflective layer 13) on one surface of the substrate 11 (for example, on the indoor side surface, which is opposite to the side from which solar light L enters). Furthermore, a pressure-sensitive adhesive layer 17 is formed on the low refractive index layer 14 of the uppermost layer of the nine-layer multilayer article (the reflective layer 13) on another surface (for example, the surface to be attached to a substrate 18 of a vehicle window or the like) of the substrate 11. In this case, the light-reflecting film 1 can be attached to the in-door (in-car or in-room) side of the substrate 18 of a vehicle window, a building glass window or the like (FIG. 1 shows the appearance after the light-reflecting film 1 has been attached to the substrate 18). Furthermore, although an example in which the primer layers 12 are formed on the both surfaces of the substrate 11 is shown in this embodiment, the reflective layers 13 may also be directly formed on the substrate 11 without forming the primer layers 12. Furthermore, a peeling layer (not illustrated) maybe disposed in advance on the pressure-sensitive adhesive layer 17, and this peeling layer may be peeled off when attaching to the substrate 18. Similarly, one or more function layer(s) such as a peeling layer (not illustrated) may be disposed in advance on the hard coat layer (HC layer) 16, and the peeling layer may be peeled off after attaching to the substrate 18. Furthermore, other layers (for example, an electroconductive layer, an antistatic layer, a gas barrier layer, an easy pressure-sensitive adhesive layer, an antifouling layer, an odor eliminating layer, a casting layer, a smoothing layer, an antiwearing layer, an antireflective layer, an electromagnetic wave shield layer, a UV absorbing layer, an infrared ray absorbing layer, a printing layer, a fluorescent layer, a hologram layer, a peeling layer, a pressure-sensitive adhesive layer, a pressure-sensitive adhesive layer, infrared ray-cutting layers other than the high refractive index layer and the low refractive index layer in the present invention (a metal layer, a liquid crystal layer), a colored layer (a visible ray absorbing layer) and an intermediate film layer utilized in laminated glass can be used singly or in suitable combination.

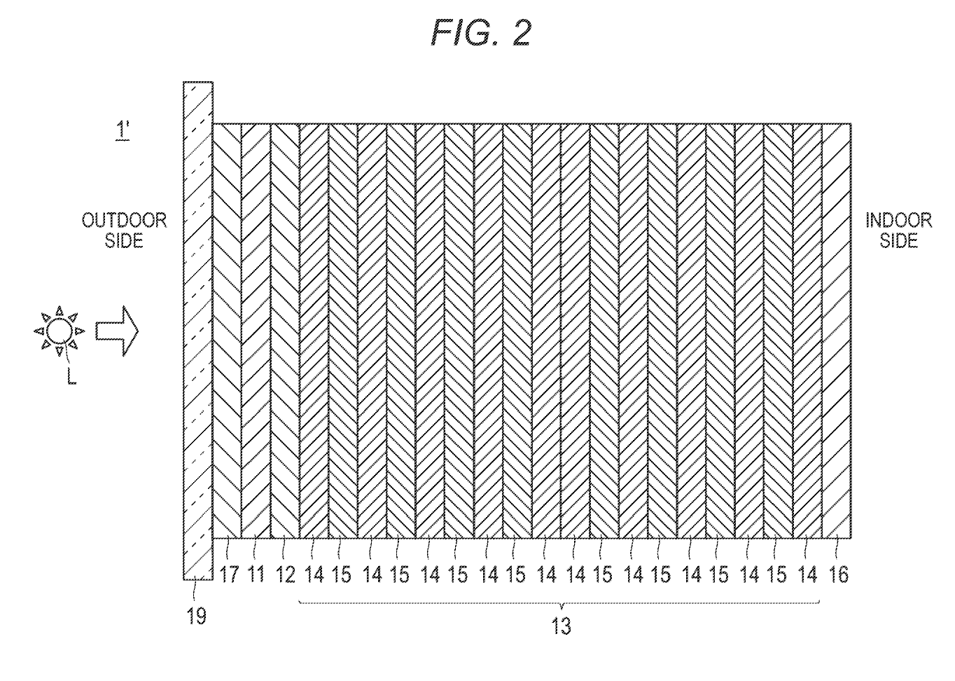

FIG. 2 shows a schematic cross-sectional view showing a general constitution of a light-reflecting film (infrared ray-shielding film) used in another exemplary embodiment of the present invention. As shown in FIG. 2, the light-reflecting film. 1′ of this embodiment has a substrate 11, a primer layer 12 formed on the substrate 11, and a reflective layer 13 formed on the primer layer 12. The reflective layer 13 is constituted so as to have at least one or more laminate (s) in which a low refractive index layer 14 and a high refractive index layer 15 are laminated. Specifically, this embodiment shown in FIG. 2 is a constitution including two sets of 4.5 laminate bodies, and has a constitution of a single-faced 18-layer multilayer article (reflective layer 13) in which a nine-layer multilayer article in which five low refractive index layers 14 and four high refractive index layers 15 are alternately laminated is formed, and a nine-layer multilayer article in which five low refractive index layers 14 and four high refractive index layers 15 are alternately laminated is further formed so as to have a similar constitution, so that the low refractive index layers 14 are formed on the lowermost layer at the side of the substrate and on the uppermost layer. In this embodiment, In this embodiment, a hard coat layer (HC layer) 16 is formed on the low refractive index layer 14 on the uppermost layer of the 18 layer multilayer article (the reflective layer 13) on one surface of the substrate 11 (for example, the indoor side, which is opposite to the side from which solar light L enters), and a pressure-sensitive adhesive layer 17 is formed on another surface (for example, the surface to be attached to a substrate 18 of a vehicle window or the like) of the substrate 11. In this case, the light-reflecting film 1 can be attached to the indoor (in-car or in-room) side of the substrate 18 of a vehicle window, a building glass window, or the like (FIG. 2 also shows the appearance after the light-reflecting film 1′ has been attached to the substrate 18). Furthermore, although an example in which the primer layer 12 is formed on one surface of the substrate 11 is shown in this embodiment, the reflective layer 13 may also be directly formed on the substrate 11 without forming the primer layer 12. Furthermore, a peeling layer (not illustrated) maybe disposed in advance on the pressure-sensitive adhesive layer 17, and the peeling layer may be peeled off when attaching to the substrate 18. Similarly, one or more function layer(s) such as a peeling layer (not illustrated) may be disposed in advance on the hard coat layer (HC layer) 16, and the peeling layer may be peeled off after attaching to the substrate 18. Furthermore, other layers (for example, an electroconductive layer, an antistatic layer, a gas barrier layer, an easy pressure-sensitive adhesive layer, an antifouling layer, an odor eliminating layer, a casting layer, a smoothing layer, an antiwearing layer, an antireflective layer, an electromagnetic wave shield layer, a UV absorbing layer, an infrared ray absorbing layer, a printing layer, a fluorescent layer, a hologram layer, a peeling layer, a pressure-sensitive adhesive layer, a pressure-sensitive adhesive layer, infrared ray-cutting layers other than the high refractive index layer and the low refractive index layer in the present invention (a metal layer, a liquid crystal layer), a colored layer (a visible ray absorbing layer) and an intermediate film layer utilized in laminated glass can be used singly or in suitable combination.

The thickness of the entirety of the light-reflecting film of the present invention is preferably from 12 μam to 315 μm, more preferably from 15 μm to 200 μm, further preferably from 20 μm to 100 μm.

### <Substrate>

The light-reflecting film of the present invention may have a substrate. The substrate that can be applied is preferably a film substrate, and the film substrate may be either transparent or opaque, and various resin films can be used. For example, polyolefin films (polyethylene, polypropylene and the like), polyester films (polyethylene telephthalate, polyethylene naphthalate and the like), polyvinyl chloride, cellulose triacetate and the like can be used, and polyester films are preferable. The polyester films (hereinafter referred to as polyesters) are not specifically limited, and are preferably polyesters each containing a dicarboxylic acid component and a diol component as major constitutional components.

Furthermore, as the substrate used in the present invention, besides the above-mentioned substrates, in the case when a laminate formed by laminating a low refractive index layer and a high refractive index layer (a dielectric multilayer film) has a self-supporting property, the dielectric multilayer film can also be used. The dielectric multilayer film having a self-supporting property is not specifically limited, and examples include dielectric multilayer films prepared by a co-extrusion process or a co-casting process, and the like.

The thickness of the substrate used in the present invention is preferably from 10 to 300 μm, specifically from 20 to 150 μm. Furthermore, two or more of the substrates of the present invention may be superposed, and in this case, the kinds of the substrates may be the same or different.

### <Reflective Layer>

In the present invention, the light-reflecting film has a reflective layer having at least one or more laminate(s) (unit (s)) in which a high refractive index layer containing a polymer and a low refractive index layer containing a polymer are laminated. The high refractive index layer and the low refractive index layer are considered as follows.

For example, there is a case when the component that constitutes the high refractive index layer (hereinafter referred to as a high refractive index layer component) and the component that constitutes the low refractive index layer (hereinafter referred to as a low refractive index layer component) are mixed at the interface of the two layers, and thus a layer containing the high refractive index layer component and the low refractive index layer component (a mixed layer) is formed. In this case, an aggregate of sites in which the high refractive index layer component is 50% by mass or more is deemed as a high refractive index layer, and an aggregate of sites in which the low refractive index layer component is 50% by mass or more is deemed as a low refractive index layer in the mixed layer. Specifically, for example, in the case when the low refractive index layer contains a first metal oxide as the low refractive index component and the high refractive index layer contains a second metal oxide as the high refractive index component, a metal oxide concentration profile is measured in the film thickness direction in these laminate films, and the layer can be deemed as a high refractive index layer or a low refractive index layer depending on the composition thereof. The metal oxide concentration profile of the laminate film can be observed by sputtering at a rate of 0.5 nm/min when the outermost surface is 0 nm and measuring an atomic composition ratio, using an XPS surface analyzer. In a laminate in which a low refractive index component or a high refractive index component does not contain the metal oxide particles and which is formed by only a water-soluble resin (an organic binder), in a similar manner, the presence of a mixing region is confirmed by measuring, for example, a carbon concentration in a film thickness direction in an organic binder concentration profile, and the composition is measured by EDX, whereby each layer etched by sputtering can be determined as the high refractive index layer or the low refractive index layer.

The above-mentioned reflective layer may have any constitution having a substrate and at least one or more laminate(s) (unit(s)) in which a high refractive index layers containing a polymer and low refractive index layers are alternately laminated on the substrate, and the upper limit of the total number of the high refractive index layers and the low refractive index layers are preferably 100 or less layers, that is, 50 units or less. Furthermore, the light-reflecting film of the present invention may have any constitution having at least one or more unit (s) on the above-mentioned substrate, and for example, the laminate film may have high refractive index layers or low refractive index layers on both of the outermost layer and the lowermost layer of the laminate film.

In the light-reflecting film (infrared ray-shielding film) of the present invention, a preferable refractive index of the high refractive index layer is from 1.70 to 2.50, more preferably from 1.80 to 2.20, further preferably from 1.90 to 2.20. Furthermore, the low refractive index layer of the present invention has a refractive index of preferably from 1.10 to 1.60, more preferably from 1.30 to 1.55, further preferably from 1.30 to 1.50.

In the light-reflecting film (the infrared ray-shielding film), it is preferable to design the difference of the refractive indices of the high refractive index layer and the low refractive index layer to be large since an infrared reflectance can be increased with a small number of layers. In the present invention, in at least one of the units each constituted by the high refractive index layer and the low refractive index layer, the difference of the refractive indices of the adjacent high refractive index layer and low refractive index layer is preferably 0.1 or more, more preferably 0.3 or more, further preferably 0.4 or more.

Furthermore, in the light-reflecting film (infrared ray-shielding film) of the present invention, the difference of the refractive indices of the adjacent high refractive index layer and low refractive index layer is preferably 0.1 or more, but in the case when the light-reflecting film has a plural number of high refractive index layers and a plural number of low refractive index layers as mentioned above, it is preferable that all of the refractive index layers satisfy the requirement as defined in the present invention. However, the outermost layer and the lowermost layer may have constitutions that are out of the requirement as defined in the present invention.

The refractive index in a specific wavelength region is determined by the difference of the refractive indices between adjacent two layers (high refractive index layer and low refractive index layer) and the number of stacked layers, and as the refractive index difference becomes larger, the same refractive index can be obtained with a smaller number of layers. The refractive index difference and the number of required layers can be calculated by using commercially available software for optical designing. For example, in order to obtain an infrared refractive index of not less than 90%, 100 layers or more are required to be stacked when the refractive index difference is less than 0.1, so that productivity is lowered, and, in addition, scattering at a lamination interface is increased, whereby transparency is lowered. Although there is no upper limit of the refractive index difference in terms of improvement of the reflectance and reduction in the number of layers, the limit of the refractive index is substantially approximately 1.40.

The difference between the refractive indices of the high refractive index layer and the low refractive index layer, which are obtained in accordance with the following method, is deemed as the difference in refractive index.

Each refractive index layer is prepared as a single layer (with the use of a substrate where necessary), this sample is cut into 10 cm×10 cm, and the refractive index thereof is then obtained in accordance with the following method. With the use of U-4000 type (manufactured by Hitachi, Ltd.) as a spectrophotometer, the surface (rear surface) on the side opposite to the measurement surface for each sample is subjected to a surface roughening treatment, and then to a light absorption treatment with a black spray to prevent light reflection at the rear surface, the reflectance in a visible light range (400 nm to 700 nm) is measured at 25 points under the condition of 5° regular reflection to obtain an average value, and from the measurement result, an average refractive index is figured out.

### [Low Refractive Index Layer and High Refractive Index Layer]

In the present description, the terms “high refractive index layer” and “low refractive index layer” mean that when the difference in refractive indices is compared between the two adjacent layers, the refractive index layer which is higher in refractive index is regarded as the high refractive index layer, whereas the refractive index layer which is lower in refractive index is regarded as the low refractive index layer. Accordingly, the terms “high refractive index layer” and “low refractive index layer” are intended to encompass all embodiments except for embodiments in which respective refractive index layers have the same refractive indices, when attention is focused on two adjacent refractive index layers among respective refractive index layers constituting a light-reflecting film.

Moreover, as optical properties of the light-reflecting film of the present invention, the transmission in a visible light range, which is measured in accordance with JIS R3106-1998, is preferably 50% or more, and the wavelength range of from 900 nm to 1,400 nm preferably has a range with a reflectivity of more than 50%.

The thickness (thickness after drying) per refractive index layer is preferably from 20 to 1,000 nm, more preferably from 50 to 500 nm.

### [Polymer]

The low refractive index layer and the high refractive index layer essentially include a polymer material. As long as it is the polymer material that forms the refractive index layer, it is possible to select a film formation method such as application or spin coating. These methods are simple, have a wide range of options because the heat resistance of a substrate material is not considered, and thus can be considered as film formation methods effective for, in particular, resin substrate materials. For example, in the cases of application type, a mass production method such as a roll-to-roll process can be adopted, which are advantageous in terms of both cost and process time. In addition, a film containing the polymer material has an advantage of being excellent in handling, since the film is highly flexible, and thus is less likely to cause these defects even when the film is wound during the production or conveyance thereof.

The polymer included in the high refractive index layer contains at least one kind selected from the group consisting of polyesters, polycarbonates and poly(meth)acrylates, because the polymer has fine film formability. The polymer constituting the high refractive index layer may have a single kind of polymer, or two or more kinds of polymers. The content rate of polyesters, polycarbonates and poly(meth)acrylates in the polymer is preferably from 60 to 100% by mass, more preferably from 80 to 100% by mass with respect to the total mass of the polymer in view of the advantageous effects mentioned above.

The polyester has a structure obtained by polycondensation of a dicarboxylic acid component and a diol component. The polyester may be a copolymer. Examples that can be used as the polyester include, for example, polyalkylene naphthalates such as polyethylene naphthalate (PEN) and isomers thereof (for example, 2,6-, 1,4-, 1,5-, 2,7-, and 2,3-PEN), polyalkylene terephthalates, (for example, polyethylene terephthalate, polypropylene terephthalate, polybutylene terephthalate and poly-1,4-cyclohexanedimethylene terephthalate), and polyethylene diphenylates. Above all, the polyester is preferably a polyalkylene terephthalate or a polyalkylene naphthalate, more preferably a polyalkylene terephthalate, and further preferably polyethylene terephthalate, because of their great infrared shielding effects, inexpensiveness, and abilities to be used in an extremely wide variety of application.

The poly (meth) acrylate is a polymer of an acrylic acid ester or a methacrylic acid ester, and examples include polymethyl methacrylate and polyethyl methacrylate.

The weight average molecular weight of the polyesters, polycarbonates and poly(meth)acrylates included in the high refractive index layer is about from 10,000 to 1,000,000, and preferably from 50,000 to 800,000. A value measured by gel permeation chromatography (GPC) is adopted for the weight average molecular weight.

The high refractive index layer may include therein other polymers besides the polyesters, polycarbonates and poly(meth)acrylates. The other polymers include polymers listed below as polymers for use in the low refractive index layer.

The polymer included in the low refractive index layer is not specifically limited, and examples include polyethylene naphthalate (PEN) and isomers thereof (for example, 2,6-, 1,4-, 1,5-, 2,7- and 2,3-PEN), polyalkylene terephthalates (for example, polyethylene terephthalate, polypropylene terephthalate, polybutylene terephthalate, and poly-1,4-cyclohexanedimethylene terephthalate), polyimide (for example, polyacrylic imide), polyether imide, atactic polystyrene, polycarbonate, polymethacrylates (for example, polyisobutyl methacrylate, polypropyl methacrylate, polyethyl methacrylate and polymethyl methactylate), polyacrylates (for example, polybutyl acrylate and polymethyl acrylate), cellulose derivatives (for example, ethyl cellulose, cellulose acetate, cellulose propionate, cellulose acetate butyrate and cellulose nitrate), polyalkylene polymers (for example, polyethylene, polypropylene, polybutylene, polyisobutylene and poly(4-methyl)pentene), fluorinated polymers (for example, perfluoroalkoxy resins, polytetrafluoroethylene, fluorinated ethylene-propylene copolymers, fluorinated vinylidenes and polychlorotrifluoroethylene), chlorinated polymers (for example, polyvinylidene chloride and polyvinyl chloride), polysulfones, polyethersulfones, polyacrylonitriles, polyamides, silicone resins, epoxy resins, polyvinyl acetate, polyether amides, ionomer resins, elastomers (for example, polybutadiene, polyisoprene and neoprene) and polyurethane. Copolymers such as, copolymers of PEN (for example, copolymers of 2,6-, 1,4-, 1,5-, 2,7- and/or 2,3-naphthalenedicarboxylic acids or esters thereof; and (a) terephthalic acid or an ester thereof, (b) isophthalic acid or an ester thereof, (c) phthalic acid or an ester thereof, (d) an alkane glycol, (e) a cycloalkane glycol (for example, cyclohexane dimethanol diol), (f) an alkane dicarboxylic acid, and/or (g) a cycloalkane dicarboxylic acid (for example, a cyclohexane dicarboxylic acid)), copolymers of polyalkylene terephthalates (for example, copolymers of terephthalic acid or an ester thereof and (a) naphthalene dicarboxylic acid or an ester thereof, (b) isophthalic acid or an ester thereof, (c) phthalic acid or an ester thereof, (d) an alkane glycol, (e) a cycloalkane glycol (for example, cyclohexane dimethanol diol), (f) an alkane dicarboxylic acid and/or (g) a cycloalkane dicarboxylic acid (for example, a cyclohexane dicarboxylic acid)), styrene copolymers (for example, a styrene-butadiene copolymer and a styrene-acrylonitrile copolymer), as well as copolymers of 4, 4′-dibenzoic acid and ethylene glycol can be also be utilized. Furthermore, the individual layers may each contain a blend of two or more of the polymers or copolymers mentioned above (for example, a blend of sPS and atactic polystyrene).

Among the foregoing, the poly(meth)acrylates, polyalkylene polymers, cellulose derivatives and the like are preferable as the polymer materials to be included in the low refractive index layer, in view of infrared shielding effect.

The weight average molecular weight of the polymer included in the low refractive index layer is about from 10,000 to 1,000,000, and preferably from 50,000 to 800,000. It is to be noted that the value measured by gel permeation chromatography (GPC) is adopted for the weight average molecular weight.

Furthermore, in the low refractive index layer, the content of the polymer is from 50 to 100% by mass, more preferably from 70 to 100% by mass with respect to the total solid content of the low refractive index.

### [Polyvinyl Alcohol-Based Resin]

In the present invention, as another embodiment, it is preferable that the polymer contained in the above-mentioned high refractive index layer and the above-mentioned low refractive index layer contains at least one kind of polyvinyl alcohol-based resin(s).

The above-mentioned polyvinyl alcohol-based resins include general polyvinyl alcohols obtained by hydrolyzing polyvinyl acetate, and also include various modified polyvinyl alcohols.

The polyvinyl alcohol obtained by hydrolyzing vinyl acetate preferably has an average polymerization degree of from 1,000 or more, and the average polymerization degree is specifically preferably from 1,500 to 5,000 (high refractive index layer: PVA-124, polymerization degree 2400, saponification degree 88 mol %, low refractive index layer:). Furthermore, the saponification degree is preferably from 70 to 100%, specifically preferably from 80 to 99.9%.

The modified polyvinyl alcohols include cation-modified polyvinyl alcohols, anion-modified polyvinyl alcohols, nonion-modified polyvinyl alcohols and vinyl alcohol-based polymers. Furthermore, vinyl acetate-based resins (for example, “Exeval” manufactured by Kuraray Co., Ltd.), polyvinyl acetal resins obtained by reacting a polyvinyl alcohol with an aldehyde (for example, “S-LEC” manufactured by Sekisui Chemical Co., Ltd.), silanol-modified polyvinyl alcohols having silanol groups (for example, “R-1130” manufactured by Kuraray Co., Ltd.), modified polyvinyl alcohol-based resins having acetacetyl groups in the molecule (for example, “Gohsefimer (registered trademark) Z/WR series” manufactured by Nippon Synthetic Chemical industry Co., Ltd.) and the like are also included in the polyvinyl alcohol-based resins.

The anion-modified polyvinyl alcohol include polyvinyl alcohols having anionic groups such as those described in JP 1-206088 A, copolymers of a vinyl alcohol and a vinyl compound having a water-soluble group such as those described in JP 61-237681 A and JP 63-307979 A, and modified polyvinyl alcohols having water-soluble groups such as those described in JP 7-285265 A.

Furthermore, the nonion-modified polyvinyl alcohols include, for example, polyvinyl alcohol derivatives formed by adding polyalkylene oxide groups to a part of a vinyl alcohol such as those described in JP 7-9758 A, block copolymers of a vinyl compound having hydrophobic groups and a vinyl alcohol such as those described in JP 8-25795 A, silanol-modified polyvinyl alcohol having silanol groups, reactive group-modified polyvinyl alcohols having reactive groups such as an acetacetyl group, a carbonyl group and a carboxyl group, and the like.

The cation-modified polyvinyl alcohols are polyvinyl alcohols each having primary to tertiary amino groups and a quaternary ammonium group in a main chain or a side chain of the above-described polyvinyl alcohol such as those described in JP 61-10483 A, and are obtained by saponifying a copolymer of an ethylenically unsaturated monomer having a cationic group and vinyl acetate.

Examples of the ethylenically unsaturated monomer having a cationic group include trimethyl-(2-acrylamide-2,2-dimethylethyl) ammonium chloride, trimethyl-(3-acrylamide-3,3-dimethylpropyl) ammonium chloride, N-vinyl imidazole, N-vinyl-2-methylimidazole, N-(3-dimethylaminopropyl) methacrylamide, hydroxyethyl trimethylammonium chloride, trimethyl-(2-methacrylamidopropyl) ammonium chloride, and N-(1,1-dimethyl-3-dimethylaminopropyl) acrylamide. The ratio of a cation modified group containing monomer of cation modified polyvinyl alcohol is from 0.1 to 10 mol % and preferably from 0.2 to 5 mol %, based on vinyl acetate.

The vinyl alcohol-based polymers include Exeval (trade name: manufactured by Kuraray Co., Ltd.), Nichigo G polymer (trade name: manufactured by Nippon Synthetic Chemical industry Co., Ltd.) and the like.

Incidentally, the above-mentioned water-soluble polymers may be used singly, or in combination of two or more kinds. Furthermore, as the water-soluble polymers, synthetic products may be used, or commercially available products may be used.

The weight average molecular weight of the water-soluble polymer is preferably from 1,000 to 200,000, more preferably from 3,000 to 60,000. Incidentally, in the present specification, a value obtained by a static light scattering process, gel permeation chromatography (GPC), TOFMASS or the like is adopted as “weight average molecular weight”. When the weight average molecular weight of the water-soluble polymer is in the above-mentioned range, it is preferable since application by a wet film formation process becomes possible, and thus the producibility can be improved.

The content of the water-soluble polymer in the refractive index layer is preferably from 5 to 75% by mass, more preferably from 10 to 70% by mass with respect to 100% by mass of the total solid content of the low refractive index layer. When the content of the water-soluble polymer is 5% by mass or more, it is preferable since, in the case when the low refractive index layer is formed by a wet film formation process, the deterioration of transparency due to the disturbance of the film surface can be prevented during the drying of the coating obtained by application. On the other hand, when the content of the water-soluble polymer is 75% by mass or less, it is preferable since, in the case when metal oxide particles are contained in the low refractive index layer, the content becomes preferable, and thus the difference in the refractive indices of the low refractive index layer and the high refractive index layer can be increased. Incidentally, in the present specification, the content of the water-soluble polymer can be obtained from a residual solid content in an evaporation drying process. Specifically, the light-reflecting film is immersed in heated water at 95° C. for 2 hours), the residual film is removed, the heated water is then evaporated, and the amount of the obtained solid is deemed as the amount of the water-soluble polymer. At this time, in the case when one peak is seen in each of regions at 1700 to 1800 cm⁻¹, 900 to 1000 cm⁻¹ and 800 to 900 cm⁻¹ in an IR (infrared spectrometry) spectrum, the water-soluble polymer can be judged as a polyvinyl alcohol.

### [Metal Oxide Particles]

In the present invention, it is preferable that the high refractive index layer and/or the low refractive index layer contains metal oxide particles.

As the metal oxide particles, a metal oxide having one kind or two or more kinds of metal (s) selected from the group consisting of Li, Na, Mg, Al, Si, K, Ca, Sc, Ti, V, Cr, Mn, Fe, Co, Ni, Cu, Zn, Rb, Sr, Y, Nb, Zr, Mo, Ag, Cd, In, Sn, Sb, Cs, Ba, La, Ta, Hf, W, Ir, Tl, Pb, Bi, and rare-earth metals as the metal(s) constituting the metal oxide can be used.

### <<Metal Oxide Particles Mainly Used in High Refractive Index Layer>>

The metal oxide particles used in the high refractive index layer include, for example, those satisfying 1.6 in refractive index among particles and composite particles such as titanium oxide, zinc oxide, aluminum oxide (alumina), zirconium oxide, hafnium oxide, niobium oxide, tantalum oxide, magnesium oxide, barium oxide, indium oxide, tin oxide and lead oxide, and composite oxides composed of these oxides, e.g., lithium niobate, potassium niobate, lithium tantalate and aluminum-magnesium oxide (MgAl₂O₄).

Furthermore, rare-earth oxides can also be used as the metal oxide particles, and specific examples include scandium oxide, yttrium oxide, lanthanum oxide, cerium oxide, praseodymium oxide, neodymium oxide, samarium oxide, europium oxide, gadolinium oxide, terbium oxide, dysprosium oxide, holmium oxide, erbium oxide, thulium oxide, ytterbium oxide and lutetium oxide.

Metal oxide particles with a refractive index of 1.90 or more are preferable as the metal oxide particles for use in the high refractive index layer, and examples can include zirconium oxide, cerium oxide, titanium oxide, zinc oxide and the like. In view of high refractive index, titanium oxide is preferable as the metal oxide particles, and it is preferable to use, in particular, rutile-type titanium oxide particles. The metal oxide particles for use in the high refractive index layer may have a single kind of metal oxide particles alone, or two or more kinds of metal oxide particles may be used in combination.

In addition, the metal oxide particles have an average primary particle diameter of preferably 100 nm or less, more preferably from 4 to 50 nm.

The average particle diameter of the metal oxide particles is obtained as the simple average value (number average) for measured particles sizes of any 1,000 particles among particles themselves or particles appearing on a cross section of or a surface of the layer, which are observed under an electron microscope. The particle diameter of each individual particle herein is expressed as a diameter in the case of assuming a circle equivalent to the projected area of the particle.

### <Titanium Oxide Particles>

In the present invention, it is preferable to use titanium oxide particles obtained by modifying the surface of a titanium oxide sol to thereby put the sol into a state being dispersible in water or an organic solvent, or the like. As methods of preparing the aqueous titanium oxide sol, the matters described in JP 63-17221 A, JP 7-819 A, JP 9-165218 A, JP 11-43327 A, JP 63-17221 A and the like can be referred to.

As other processes for producing the titanium oxide particles, “Titanium Oxide—physicality and applied technology”, Manabu Seino, p 255 to 258 (2000), Gihodo Shuppan Co., Ltd. and a method of a process (2) described in paragraphs “0011” to “0023” of the specification of WO 2007/039953 A can be referred to, for example. The production process according to the process (2) includes a process (1) in which a titanium dioxide hydrate is treated with at least one kind of basic compounds selected from the group consisting of a hydroxide of an alkali metal or a hydroxide of an alkaline earth metal and the process (2) in which an obtained titanium dioxide dispersion is treated with a carboxylic acid group-containing compound and inorganic acid after the process (1).

The volume average particle diameter of the titanium oxide used as the first metal oxide particles in the present invention is preferably 100 nm or less, more preferably 50 nm or less, and from the viewpoints of a low haze value and an excellent visible light transmittance, the volume average particle diameter is further preferably from 1 to 30 nm, more preferably from 1 to 20 nm. Incidentally, the volume average particle diameter used herein is an average particle diameter obtained by measuring the particle diameters of optional 1,000 particles by a method of observing the particles themselves by a laser diffraction scattering process, a kinetic light scattering process, or a method of observing by using an electronmicroscope, or a method of observing an image of the particles appeared on the cross-sectional surface or surface of the refractive index layer by an electron microscope, and weighting by a volume represented by volume average particle diameter mv={Σ(vi·di)}/{Σ(vi)}, wherein vi is a volume per one particle in a population of particular metal oxide in which particles respectively having particle diameters of d1, d2 . . . di . . . dk are present in respective numbers of n1, n2 . . . ni . . . nk.

Alternatively, in the present invention, the titanium oxide may be in a form of core-shell particles each coated by a silicon-containing hydrated oxide. The core-shell particles each has a structure in which the surface of the titanium oxide particle as a core is coated with a shell formed of a silicon-containing hydrated oxide. By incorporating such core-shell particles in the high refractive index layer, the interlayer mixing between the low refractive index layer and the high refractive index layer can be suppressed by the interaction of the silicon-containing hydrated oxide in the shell layer and the water-soluble resin.

In the present description, “coating” means a state in which silicon-containing hydrated oxide is adhering to at least a part of the surface of each titanium oxide particle. That is, the surface of each titanium oxide particle used as the first metal oxide particles in the present invention may be completely coated with the silicon-containing hydrated oxide, or a part of the surface of each titanium oxide particle may be coated with the silicon-containing hydrated oxide. From the viewpoint that the refractive index of the coated titanium oxide particles is controlled by the coating amount of the silicon-containing hydrated oxide, it is preferable that a part of the surface of the titanium oxide particle is coated with the silicon-containing hydrated oxide.

As the above-mentioned silicon-containing hydrated oxide, either of a hydrate of an inorganic silicon compound or a hydrolysate of an organic silicon compound and/or condensations thereof may be used, and preferably has silanol groups. Therefore, it is preferable that the above-mentioned core-shell particles are silica-modified (silanol-modified) titanium oxide particles formed by modifying titanium oxide particles with silica.

A known method can be adopted to such silica-modified titanium oxide particles, and examples can include the methods shown in the following (i) to (v).

(i) The method in which an aqueous solution containing titanium oxide particles is heated and hydrolyzed, or an alkali is added to the aqueous solution containing titanium oxide particles to neutralize, whereby titanium oxide having an average particle diameter of 1 to 30 nm is obtained. Then, a slurry in which the titanium oxide particles and a mineral acid are mixed so that the titanium oxide particles/the mineral acid is within a range of from 1/0.5 to 1/2 by a molar ratio is heat-treated at a temperature of 50° C. or more and the boiling point of the slurry or more. Thereafter, the obtained slurry containing the titanium oxide particle is added with a silicon compound (for example, an aqueous sodium silicate solution, a hydrated oxide of silicon is precipitated on the surfaces of the titanium oxide particles, the surfaces are then treated, and impurities are then removed from the slurry of the obtained surface-treated titanium oxide particle (the method described in JP 10-158015 A).

(ii) The method in which a titanium oxide sol stabilized at a pH of an acidic region obtained by deflocculating titanium oxide such as hydrated titanium oxide with a monobasic acid or a salt thereof and an alkyl silicate as a dispersion stabilizer are mixed and neutralized by an ordinary method (the method described in JP 2000-053421 A).

(iii) Hydrogen peroxide and metallic tin are simultaneously or alternately added to a mixed aqueous solution of a titanium salt (such as titanium tetrachloride) and the like while maintaining a H₂O₂/Sn molar ratio of 2 to 3, whereby a titanium-containing aqueous solution of a basic salt is produced, the aqueous solution of a basic salt is held at a temperature of from 50 to 100° C. for from 0.1 to 100 hours to produce an aggregate of a composite colloid containing titanium oxide, an electrolyte in the aggregate slurry is then removed, whereby a stable aqueous sol of composite colloidal particles containing titanium oxide is produced. Meanwhile, an aqueous solution containing a silicate (such as a sodium silicate aqueous solution) and the like is prepared, and cations existing in the aqueous solution are removed, whereby a stable aqueous sol of composite colloidal particles containing silicon dioxide is produced. 100 parts by mass of the obtained composite aqueous sol containing titanium oxide in terms of metal oxide TiO₂ is mixed with 2 to 100 parts by mass of the obtained composite aqueous sol containing silicon dioxide in terms of SiO₂, anions are removed, and heat aging is conducted at 80° C. for 1 hour (the method described in JP 2000-063119 A).

(iv) The method in which hydrous titanic acid is dissolved by adding hydrogen peroxide to a gel or sol of hydrous titanic acid, a silicon compound and the like are added to an obtained peroxotitanic acid aqueous solution and heated, whereby a dispersion liquid of core particles composed of composite solid-solution oxide having a rutile type structure is obtained, a silicon compound and the like are subsequently added to the dispersion liquid of core particles and thereafter heated to form a coating layer on the surface of each core particle to obtain a sol with dispersed composite oxide particles, and heating is further conducted (the method described in JP 2000-204301 A).

(v) The method in which a hydrosol obtained by deflocculating hydrous titanium oxide is added with a compound as a stabilizer selected from an organoalkoxysilane (R1ₙSiX₄₋ₙ) or hydrogen peroxide and an aliphatic or aromatic hydroxycarboxylic acid, the pH of the solution is adjusted to be 3 or more and less than 9, the solution is aged, and then a desalting treatment is conducted (the method described in JP 4550753 A).

In order to adjust the amount of coating of the titanium oxide particles as the first metal oxide particles in the present invention with the silicon-containing hydrated oxide, examples of the method include (1) a method in which the coating amount of the silicon-containing hydrated oxide is adjusted by adjusting the amount of the silicon compound added to the titanium oxide particles used in the above-mentioned methods (i) and (iv); (2) a method in which the coating amount of the silicon-containing hydrated oxide is adjusted by converting the composite aqueous sol containing titanium oxide and composite aqueous sol containing silicon dioxide as obtained to metal oxides TiO₂ and SiO₂, respectively, and adjusting the amount of the corresponding SiO₂ to the corresponding TiO₂ in the above-mentioned method (iii); (3) a method in which the coating amount of the silicon-containing hydrated oxide is adjusted by adjusting the addition amount of the organoalkoxysilane used in the above-mentioned method (v); and (4) a method in which the addition amount of the alkyl silicate is adjusted in the above-mentioned method (ii); and the like.

When the silica-modified titanium oxide particles are prepared in the present invention, in a suspension liquid containing the titanium oxide particles coated with the silicon-containing hydrated oxide, a preferable solid content concentration in the silica-modified titanium oxide particles with respect to the solid content (100% by mass) of the entirety of the suspension liquid is from 1 to 40% by mass. Furthermore, the solid content concentration is more preferably from 15 to 25% by mass. This is because, by presetting the solid content concentration to 1% by mass or more, the solid content concentration increases to thereby decrease the load of the volatilization of the solvent, and by presetting the solid content concentration to be 40% by mass or less, flocculation by a high density of the particles can be prevented, and thus the defects during application can be decreased. In the preparation of the first metal oxide particles in the present invention, the range of the pH of the suspension liquid containing the titanium oxide particles coated with the silicon-containing hydrated oxide is preferably from 3 to 9, more preferably from 4 to 8. This is because, by presetting the pH of the suspension liquid to 9 or less, the change in volume average particle diameter due to alkali dissolution can be suppressed, and by presetting the pH of the suspension liquid to be 3 or more, the handling property can be improved.

In the above-mentioned silica-modified titanium oxide particles, the coating amount of the silicon-containing hydrated oxide in terms of SiO₂ is preferably from 3 to 30% by mass, more preferably from 3 to 10% by mass, further preferably from 3 to 8% by mass with respect to the titanium oxide particles. If the coating amount is from 3 to 30% by mass, the refractive index of the high refractive index layer is easily increased, and the coated particles can be stably formed.

### <Rutile-Type Titanium Oxide>

Generally, titanium oxide particles are used in a surface-treated state in many cases for the purposes of suppressing the light catalyst activity of the surfaces of the particles, improving the dispersibility in a solvent, and the like, and for example, silica-modified titanium oxide particles in which the surface of each titanium oxide particle is coated with a coating layer formed of silica, and silica-modified titanium oxide particles in which the surfaces of the particles are negatively charged, and silica-modified titanium oxide particles in which a coating layer formed of an aluminum oxide is formed on each particle, having a pH of from 8 to 10, and the surfaces are positively charged, are known.

Furthermore, it is preferable that the titanium oxide particles have monodispersibility. The monodispersion herein refers to that a degree of monodispersion obtained by the following formula is 40% or less. Furthermore, the particles have a degree of monodispersion of preferably 30% or less, specifically preferably from 0.1 to 20%.

Degree of monodispersion=(standard deviation of particle diameters)/(average value of particle diameter)×100

The content of the metal oxide particles in the high refractive index layer is preferably from 20 to 80% by mass, more preferably from 30 to 70% by mass, further preferably from 40 to 60% by mass with respect to 100% by mass of the solid content of the high refractive index layer, from the viewpoint of infrared ray-shielding, and in view of decreasing of unevenness of a color in the case when the film is applied to glass having a curved surface shape.

<<Metal Oxide Particles that are Mainly Used in Low Refractive Index Layer>>

As the metal oxide particles that are mainly used in the low refractive index layer, silicon oxide is preferably used as the metal oxide particles, and it is specifically preferable to use colloidal silica. The metal oxide particles (preferably silicon dioxide) contained in the low refractive index layer preferably have an average particle diameter of from 3 to 100 nm. The average particle diameter for primary particles of silicon dioxide dispersed in a primary particle state (the particle diameter in a dispersion liquid state before application) is more preferably from 3 to 50 nm, further preferably from 3 to 40 nm, particularly preferably from 3 to 20 nm, and most preferably from 4 to 10 nm. In addition, the average particle diameter for secondary particles is preferably 30 nm or less from the viewpoints of less haze and excellent visible light transmission properties. The average particle diameter for the metal oxide in the low refractive index layer is obtained as the simple average value (number average) for measured particles sizes of any 1,000 particles among particles themselves or particles appearing on a cross section of or a surface of the refractive index layer, which are observed under an electron microscope. The particle diameter of each individual particle herein is expressed as a diameter in the case of assuming a circle equivalent to the projected area of the particle.

From the viewpoints of the refractive index, the content of the metal oxide particles in the low refractive index layer is preferably from 30 to 90% by mass, further preferably from 40 to 80% by mass with respect to 100% by mass of the solid content of the low refractive index layer.

The colloidal silica is obtained by double decomposition of sodium silicate with an acid or the like, or by heat-aging silica sol obtained by passing through an ion-exchange resin layer, and examples include those disclosed in, for example, JP 57-14091 A, JP 60-219083 A, JP 60-219084 A, JP 61-20792 A, JP 61-188183 A, JP 63-17807 A, JP 4-93284 A, JP 5-278324 A, JP 6-92011 A, JP 6-183134 A, JP 6-297830 A, JP 7-81214 A, JP 7-101142 A, JP 7-179029 A, JP 7-137431 A and WO 94/26530A and the like. For such colloidal silica, synthesized products may be used, or commercially available products may be used. The colloidal silica may have a surface subjected to cation modification, or subjected to treatment with Al, Ca, Mg, Ba, or the like.

In addition, various types of additives can be incorporated in the high refractive index layer and low refractive index layer in the present invention, if necessary.

The layers may contain various types of known additives such as UV absorbers described in JP 57-74193 A, JP 57-87988 A, and JP 62-261476 A, antifading agents described in JP 57-74192 A, JP 57-87989 A, JP 60-72785 A, JP 61-146591 A, JP 1-95091 A and JP 3-13376 A, various types of anionic, cationic, or non-ionic surfactants, fluorescent brighteners described in JP 59-42993 A, JP 59-52689 A, JP 62-280069 A, JP 61-242871 A and JP 4-219266 A, pH adjusters such as sulfuric acid, phosphoric acid, acetic acid, citric acid, sodium hydroxide, potassium hydroxide and potassium carbonate, antifoamers, lubricants such as diethylene glycol, preservatives, antistatic agents, and matting agents.

### <Pressure-Sensitive Adhesive Layer>

The light-reflecting film of the present invention has a pressure-sensitive adhesive layer. The pressure-sensitive adhesive that constitutes the pressure-sensitive adhesive layer is not specifically limited, and acrylic-based pressure-sensitive adhesives, silicon-based pressure-sensitive adhesives, urethane-based pressure-sensitive adhesives, polyvinyl butyral-based pressure-sensitive adhesives, ethylene-vinyl acetate-based pressure-sensitive adhesives and the like can be exemplified.

The light-reflecting film of the present invention exhibits an instantaneous pressure-sensitive adhesive force when applied to glass of from 2 to 8 N/25 mm, and the instantaneous pressure-sensitive adhesive force is preferably from 4 to 8 N/25 mm. The instantaneous pressure-sensitive adhesive force refers to a pressure-sensitive adhesive force of the pressure-sensitive adhesive layer measured at after 24 hours from the attaching of the light-reflecting film of the present invention to glass.

The pressure-sensitive adhesive force of the pressure-sensitive adhesive layer can be adjusted by variously selecting the materials that constitute the pressure-sensitive adhesive layer.

Furthermore, it is preferable that the instantaneous pressure-sensitive adhesive force exhibited when the pressure-sensitive adhesive layer is applied to glass is from 4 to 8 N/25 mm, and the pressure-sensitive adhesive force over time when the pressure-sensitive adhesive layer and the glass are left with keeping the attached state under conditions of 30° C. and a humidity of 60% RH for 1 week is from 7 to 15 N/25 mm in view of curved surface tight adhesiveness. Furthermore, it is more preferable that the above-mentioned pressure-sensitive adhesive force over time is from 10 to 15 N/25 mm from the viewpoints of improvement of durability and decreasing of adhesive residue. The pressure-sensitive adhesive force over time refers to the pressure-sensitive adhesive force of the pressure-sensitive adhesive layer measured after attaching the light-reflecting film of the present invention to glass, and measuring after a predetermined period has passed.

In the case when the light-reflecting film of the present invention is attached to window glass, a method including spraying water onto the window and the pressure-sensitive adhesive layer of the light-reflecting film is combined with the glass surface in a wet state, so-called a water-attaching process is preferably used in view of re-attaching, re-positioning and the like. Therefore, under wetting in which water is present, a pressure-sensitive adhesive that exhibits a weak pressure-sensitive adhesive force is preferable.

This pressure-sensitive adhesive layer can also contain additives such as a stabilizer, a surfactant, a UV absorber, a silane coupling agent, a flame retarder, an antistatic agent, an antioxidant, a heat ray-shielding stabilizer, a lubricant, a filler, a colorant, an adhesion controlling agent and the like. Specifically, in the case when the light-reflecting film is used for attaching to windows, it is effective to add a UV absorber so as to suppress the deterioration of the light-reflecting film by ultraviolet ray.

The layer thickness of the pressure-sensitive adhesive layer is preferably from 1 to 100 μm, more preferably from 3 to 50 μm. If the layer thickness is 1 μm or more, the pressure-sensitive adhesivity tends to be improved, and thus a sufficient pressure-sensitive adhesive force can be obtained. Conversely, if the layer thickness is 100 μm or less, the transparency of the light-reflecting film is improved, and cohesive failure does not occur between the pressure-sensitive adhesive layers when the light-reflecting film is attached to a window glass and then peeled off, and thus adhesive residue on the glass surface tends to be eliminated.

The method for forming the pressure-sensitive adhesive layer on the reflective layer is not specifically limited, and a method including applying an application liquid for a pressure-sensitive adhesive layer onto a separator and drying the application liquid to form a pressure-sensitive adhesive layer, separately from the reflective layer, and bonding the pressure-sensitive adhesive layer and the reflective layer together, is preferable.

Examples of the separator used at this time include a silicone-coated mold release PET film, a silicone-coated PE film and the like. The method for applying the application liquid for a pressure-sensitive adhesive layer onto the separator is not specifically limited, and a method for forming a film by applying an application liquid by means of coating with a wire bar, spin coating, dip coating or the like is exemplified, and it is also possible to apply and form a film by means of a continuous application apparatus such as a die coater, a gravure coater, a comma coater or the like.

Incidentally, in the present description, “pressure-sensitive adhesive force” is obtained by measuring in accordance with the JIS A5759:2008 6.8 Pressure-sensitive Adhesive Force Test, and more specifically, the pressure-sensitive adhesive force is measured according to the method described in the following Examples.

### <Hard Coat Layer>

The light-reflecting film of the present invention has a hard coat layer (hereinafter simply referred to as a HC layer) as a surface protective layer for enhancing abrasion resistance, on the surface opposite to the surface on which the pressure-sensitive adhesive layer is formed of the dielectric multilayer film.

As the hard coat material that constitutes the hard coat layer in the present invention, materials that exhibit small shrinkage stress after curing such as inorganic-based materials as represented by polysiloxane-based materials, and curable resins such as UV-curable urethane acrylate resins, are preferable. These hard coat materials can be used either singly or by mixing two or more kinds.

As the polysiloxane-based hard coat material that can be applied to the formation of the hard coat layer in the present invention, a compound represented by the following General Formula (1) is preferable.

[Chemical Formula 1]

(R)ₘSi(ORᵢ)ₙ Chemical Formula (1)

In the above-mentioned General Formula (1), R and R₁ are each independently, a linear, branched or cyclic alkyl group having 1 to 10 carbon(s), and m and n are integers satisfying the relationship of m+n=4.

Specific compounds include tetramethoxysilane, tetraethoxysilane, tetra-iso-propoxysilane, tetra-n-poropoxysilane, tetra-n-butoxysilane, tetra-sec-butoxysilane, tetra-tert-butoxysilane, terorapentaethoxysilane, tetrapenta-iso-propoxysilane, tetrapenta-n-propoxysilane, tetrapenta-n-butoxysilane, tetrapenta-sec-butoxysilane, tetrapenta-tert-butoxysilane, methyltriethoxysilane, methyltripropoxysilane, methyltributoxysilane, dimethyldimethoxysilane, dimethyldiethoxysilane, dimethylethoxysilane, dimethylmethoxysilane, dimethylpropoxysilane, dimethylbutoxysilane, dimethyldimethoxysilane, dimethyldiethoxysilane, hexyltrimethoxysilane and the like. Furthermore, γ-(2-aminoethyl)aminopropyltrimethoxysilane, γ-(2-aminoethyl)aminopropylmethyldimethoxysilane, β-(3,4-epoxycyclohexyl)ethyltrimethoxysilane, N-β-(N-aminobenzylaminoethyl)-γ-aminopropylmethoxysilane hydrochloride, γ-glycidoxypropyltrimethoxysilane, aminosilane, methylmethoxysilane, vinyltriacetoxysilane, γ-mercaptopropyltrimethoxysilane, γ-chloropropyltrimethoxysilane, hexamethyldisilazane, vinyltris(β-methoxyethoxy)silane and octadecyldimethyl [3-(trimethoxysilyl) propyl] ammonium chloride can also be exemplified. Polyorganosiloxane-based hard coat materials generally refer to materials in a state in which hydrolysable groups such as methoxy groups and ethoxy groups of these compounds have been substituted with hydroxy groups.

As the above-mentioned polyorganosiloxane-based hard coat materials, Surcoat series BP-16N (these are manufactured by Doken Co., Ltd.), SR2441 (manufactured by Dow Corning Toray), Perma-New 6000 (manufactured by California Hardcoating Company) and the like can be specifically utilized.

Furthermore, as the curable resin used in the hard coat layer in the present invention, thermally-curable resins and actinic ray curable resins are exemplified, and actinic ray curable resin are preferable due to easy molding. Such curable resins can be used either singly or in combination of two or more kinds.

It is also preferable to use an actinic ray curable resin as the hard coat material. An actinic ray curable resin refers to a resin that is cured via a crosslinking reaction or the like by irradiation with actinic ray such as UV or electron beam. As the actinic ray curable resin, a component containing a monomer having an ethylenically unsaturated double bond is preferably used, and the actinic ray curable resin is cured by irradiating with actinic ray such as ultraviolet ray or electron beam, whereby an actinic ray curable resin layer, that is, a hard coat layer, is formed. Typical examples of the actinic ray curable resins include UV-curable resins, electron beam curable resins and the like, and UV-curable resins, which are cured by irradiation with ultraviolet ray, are preferable.

As the UV-curable resins, for example, UV-curable urethane acrylate resins, UV-curable polyester acrylate resins, UV-curable epoxyacrylate resins, UV-curable polyol acrylate resins, UV-curable acryl acrylate resin or UV-curable epoxy resins and the like are preferably used. Generally, the UV-curable urethane acrylate resins can be easily obtained by reacting a polyester polyol with an isocyanate monomer or a prepolymer, and further reacting the obtained product with an acrylate-based monomer having a hydroxyl group such as 2-hydroxyethyl acrylate, 2-hydroxyethyl methacrylate (hereinafter only acrylates are indicated with deeming that acrylates encompass methacrylates) or 2-hydroxypropyl acrylate. For example, a mixture of 100 parts by mass of UNIDIC (registered trademark) 17-806 (manufactured by DIC) and 1 part by mass of Coronate (registered trademark) L (manufactured by Nippon Polyurethane Industry Co., Ltd.) described in JP 59-151110A, and the like are preferably used. Generally, the UV-curable polyester acrylate resins can be easily obtained by reacting hydroxyl groups or carboxyl groups at the terminals of a polyester with a monomer such as 2-hydroxyethyl acrylate, glycidyl acrylate or acrylic acid (for example, JP 59-151112 A). The UV-curable epoxy acrylate resins can be obtained by reacting the hydroxyl groups at the terminals of an epoxy resin with a monomer such as acrylic acid, acrylic acid chloride or glycidyl acrylate. Examples of the UV-curable polyol acrylate resins can include resins obtained by curing one kind or two or more kinds of monomers such as ethylene glycol (meth) acrylate, polyethylene glycol di(meth)acrylate, glycerin tri(meth)acrylate, trimethylolpropane triacrylate, pentaerythritol triacrylate, pentaerythritol tetraacrylate, dipentaerythritol pentaacrylate, dipentaerythritol hexaacrylate, alkyl-modified dipentaerythritol pentaacrylates and pentaerythritol ethylene oxide-modified tetraacrylate.

Besides the above-mentioned commercially available products of the actinic ray curable resins that are used for forming the hard coat layer, other examples of the commercially available products can include Beamset 577 (manufactured by Arakawa Chemical Industries, Ltd.), Hitaloid (registered trademark) series (manufactured by Hitachi Chemical Co., Ltd.), Shiko series (manufactured by Nippon Synthetic Chemical Industry Co., Ltd.), ETERMER 2382 (manufactured by ETERNAL CHEMICAL) and the like.

Furthermore, it is desirable that the hard coat layer has a constitution that does not promote shrinkage even under a situation that the hard coat layer is exposed to solar light. Therefore, it is preferable that the hard coat layer contains a UV absorber and/or an antioxidant. The content of these UV absorber and antioxidant is preferably 0.05% by mass or more and 4% by mass or less, preferably 0.1% by mass or more and 3% by mass or less with respect to the total mass of the hard coat layer. The reason is that, in the case when the hard coat layer is irradiated with UV, the reaction in the hard coat layer is promoted, and thus the shrinkage stress increases. Furthermore, since the resin is decomposed in the hard coat layer, a phenomenon that the hard coat layer itself becomes brittle may occur. Therefore, by incorporating the UV absorber and antioxidant in the hard coat layer, the shrinkage and decomposition of the hard coat layer can be suppressed, and thus the weather-resistance tight adhesiveness can be improved.

(Elastic modulus of Pressure-Sensitive Adhesive Layer and Elastic Modulus of Hard Coat Layer)

The elastic modulus of the pressure-sensitive adhesive layer and the elastic modulus of the hard coat layer of the light-reflecting film of the present invention satisfies the following Formula (1).

Formula (1): the elastic modulus of the hard coat layer [Pa]/the elastic modulus of the pressure-sensitive adhesive layer [Pa]≧3

Since that the elastic modulus of the pressure-sensitive adhesive layer and the elastic modulus of the hard coat layer satisfy the above-mentioned Formula (1) and that the instantaneous pressure-sensitive adhesive force exhibited when the pressure-sensitive adhesive layer is applied to glass is from 2 to 8 N/25 mm are satisfied, a light-reflecting film that, while ensuring tight adhesiveness to an adherend having a curved surface, leaves little adhesive residue when peeled from an adherend for the purposes of re-attaching, can be re-attached, and is excellent in durability and heat ray-shielding conductance, can be provided. From the viewpoint of the tight adhesiveness to an adherend having a curved surface, the above-mentioned Formula (1) is preferably such that the elastic modulus of the hard coat layer [Pa]/the elastic modulus of the pressure-sensitive adhesive layer [Pa]≧3, more preferably such that the elastic modulus of the hard coat layer [Pa]/the elastic modulus of the pressure-sensitive adhesive layer [Pa]≧4. Although the upper limit is not specifically limited, the elastic modulus of the hard coat layer [Pa]/the elastic modulus of the pressure-sensitive adhesive layer [Pa]≦20, preferably the elastic modulus of the hard coat layer [Pa]/the elastic modulus of the pressure-sensitive adhesive layer [Pa]≦10, since the efficiency during attaching to the curved glass can be maintained, and for effectively preventing peeling after attaching.

The elastic modulus can be measured by a nanoindentation process, in which an indenter is continuously loaded on a sample at a ultrafine loading, the load is then removed, and an elastic modulus is obtained from the obtained load—displacement curve.

The elastic modulus of the pressure-sensitive adhesive layer and the elastic modulus of the hard coat layer can be respectively adjusted by variously selecting materials for constituting those layers.

### <Heat Ray-Shielding Microparticles>

Furthermore, in view of a heat ray shielding effect, it is preferable to incorporate heat ray-shielding microparticles having heat ray shielding absorbability in the light-reflecting film. It is preferable that the above-mentioned heat ray-shielding microparticles have an average particle diameter of 0.2 μm or less. This is because the reflection of visible light becomes indistinctive due to the scattering and absorption by the heat ray-shielding microparticles. Examples of the heat ray-shielding microparticles include metals of Sn, Ti, Si, Zn, Zr, Fe, Al, Cr, Co, Ce, In, Ni, Ag, Cu, Pt, Mn, Ta, W, V and Mo, oxides, nitrides and sulfides thereof, or doped products thereof with Sb, Sn or F, each by itself, or composites of at least two or more selected from these, and antimony doped tin oxide (ATO) or indium tin oxide (ITO) is preferable in view of heat-ray shielding effect.

As the heat ray-shielding microparticles, a synthetic product may be used, or a commercially available product may be used. Examples of the commercially available product include zinc oxide-based products such as Celnax (registered trademark) series (manufactured by Nissan Chemical Industries, Ltd.), Pazet series (manufactured by Hakusui Tech), tin oxide-based products such as ATO dispersion liquid (Examples) and ITO dispersion liquid (these are manufactured by Mitsubishi Materials Corporation), KH series (manufactured by Sumitomo Metal Mining Co., Ltd.), and the like. Examples of the organic-based commercially available products include NIR-IM1 and NIR-AM1 (these are manufactured by Nagase ChemteX Corporation), Lumogen (registered trademark) series (manufactured by BASF), and the like.

The average particle diameter for the heat ray-shielding microparticles is 0.2 μm or less because the heat ray-shielding effect can be ensured while suppressing the reflections of visible light, and because transparency can be ensured without the deterioration of haze by scattering, and 0.15 μm or less is preferable. The lower limit of the average particle diameter is not specifically limited, but is preferably 0.10 μm or more. The average particle diameter is obtained as the simple average value (number average) for measured particles sizes of any 1,000 particles among particles themselves or particles appearing on a cross section of or a surface of the refractive index layer, which are observed under an electron microscope. The particle diameter of each individual particle herein is expressed as a diameter in the case of assuming a circle equivalent to the projected area of the particle.

The above-mentioned heat ray-shielding microparticles can be incorporated in the hard coat layer. The content of the heat ray-shielding microparticles is preferably 55% by mass or more and 80% by mass or less with respect to the total mass of the hard coat layer. It is preferable that the content is in this range since the above-mentioned resin component in the hard coat layer decreases, and thus the shrinkage stress decreases. In the case when the content of the infrared ray absorbing agent is less than 55% by mass, the layer thickness of the hard coat layer becomes thick, and the shrinkage stress tends to increase and the weather resistance tends to be poor. On the other hand, in the case when the content is more than 80% by mass, the resin component is too small, and thus the hard coat layer is put in a state in which particles are excessively present, and it is possible that the hard coat layer does not exhibit its hardness.

Furthermore, the hard coat layer may contain inorganic microparticles other than the above-mentioned infrared ray absorbing agent. Examples of preferable inorganic microparticles include microparticles of an inorganic compound containing a metal such as titanium, silica, zirconium, aluminum, magnesium, antimony, zinc or tin, or the like. The average particle diameter of the inorganic microparticles is preferably 1,000 nm or less, more preferably in the range of from 10 to 500 nm so as to ensure visible ray permeability. Furthermore, it is preferable that the inorganic microparticles are such that photopolymerization reactive photosensitive groups such as monofunctional or multifunctional acrylates or the like have been introduced on the surface, since dropping off from the hard coat layer can be suppressed more at a higher bonding force with the curable resin forming the hard coat layer.

Furthermore, the hue can be adjusted by adding a dye or a pigment to the hard coat layer. For example, colored inorganic pigments such as cadmium red, molybdenum red, chromium permilion, chromium oxide, viridian, titanium cobalt green, cobalt green, cobalt chromium green, Victoria green, azure blue, ultramarine blue, Prussian blue, Berlin blue, Milori blue, cobalt blue, Cerulian blue, cobalt silica blue, cobalt zinc blue, manganese violet, mineral violet and cobalt violet, organic pigments such as phthalocyanine pigments, and anthraquinone-based dye are preferably used.

The layer thickness of the hard coat layer is preferably from 0.1 to 50 μm, more preferably from 1 to 20 μm. When the layer thickness is 0.1 μm or more, the hard coat property tends to be improved, whereas when the layer thickness is 50 μm or less, the film transparency of the reflective layer film tends to be improved.

As the method for forming the hard coat layer on the reflective layer film, a method for forming a film by applying a application liquid for a hard coat layer on the reflective layer formed of a high refractive index layer and a low refractive index layer by means of coating with a wire bar, spin coating, dip coating or the like, and the film can also be formed by a dry film formation process such as deposition. Furthermore, it is also possible to apply and form a film by means of a continuous application apparatus such as a die coater, a gravure coater, a comma coater or the like. For example, in the case of a polysiloxane-based hard coat material, it is preferable to apply the hard coat material, dry the solvent, and conduct a heat treatment within a temperature range of from 50 to 150° C. for from 30 minutes to several days so as to promote the curing and crosslinking of the hard coat material. With consideration for the heat-resistance of the applied substrate and the stability of the substrate when formed into a laminated roll, it is preferable to conduct the treatment within the range of from 40 to 80° C. for 2 or more days. In the case when the actinic ray curable resin is used, it cannot be generally said, since the reactivity thereof varies depending on the irradiation wavelength, illuminance and amount of light of actinic ray, and thus it is necessary to select optimal conditions depending on the resin used. However, for example, in the case when a UV lamp is used as the actinic ray, the illuminance is preferably from 50 to 1,500 mW/cm², and the amount of irradiated energy is preferably from 50 to 1,500 mJ/cm².

As the solvent used for the application liquid for the hard coat layer, the solvents exemplified in the above-mentioned column of <Hard Coat Layer> are exemplified.

A surfactant can be added to the application liquid for forming the hard coat layer to thereby impart leveling property, water repelling property, slippage and the like. The kind of the surfactant is not specifically limited, and an acrylic-based surfactant, a silicon-based surfactant, a fluorine-based surfactant or the like can be used. Specifically, from the viewpoints of leveling property, water repelling property and slippage, it is preferable to use a fluorine-based surfactant. As the fluorine-based surfactant, for example, commercially available products such as Megafac (registered trademark) F series (F-430, F-477, F-552 to F-559, F-561, F-562 and the like) manufactured by DIC, Megafac (registered trademark) RS series (RS-76-E and the like) manufactured by DIC, Surflon (registered trademark) series manufactured by AGC Seimi Chemical Co., Ltd., POLYFOX series manufactured by OMNOVA SOLUTIONS, ZX series by T&K TOKA, Optool series manufactured by Daikin Industries, Ltd., and Ftergent (registered trademark) series manufactured by NEOS Company Ltd. can be used.

The hard coat layer included in the light-reflecting film of the present invention maybe only one layer, or two or more layers. in the case when the light-reflecting film has two or more layers, the constitutions of the respective hard coat layer may be the same or different.

### <Method for Producing Light-Reflecting Film (Infrared Ray-Shielding Film)>

The method for producing the light-reflecting film according to the present invention is not specifically limited, but any method can be used as long as the method can form at least one laminate in which a high refractive index layer and a low refractive index layer are alternately laminated.

The method for producing the light-reflecting film according to the present invention forms the film by laminating a unit composed of a high refractive index layer and a low refractive index layer. Specifically, examples of the method include: (1) a method of forming a laminate by alternately applying the high refractive index layers and the low refractive index layers onto a substrate, and drying the layers; and (2) a method of forming a film by drawing a laminate after the formation of the laminate by co-extrusion. According to the present invention, the high refractive index layer contains therein a metal oxide, and thus the film can be prepared by both the production methods (1) and (2) mentioned above.

As the coating method in the method of the above-mentioned (1), for example, a roll coating method, a rod bar coating method, an air knife coating method, a spray coating method, a curtain coating method, a slide bead coating method using a hopper described in U.S. Pat. Nos. 2,761,419 and 2,761,791, and an extrusion coating method are preferably used.

Specific examples of the method of the above-mentioned (1) include the following embodiments: (1) a method of forming a film by applying a high refractive index layer application liquid onto a substrate and drying the liquid to form a high refractive index layer, and then applying a low refractive index layer application liquid and drying the liquid to form a low refractive index layer; (2) a method of forming a film by applying a low refractive index layer application liquid onto a substrate and drying the liquid to form a low refractive index layer, and then applying a high refractive index layer application liquid and drying the liquid to form a high refractive index layer; (3) sequentially applying, onto a substrate, and drying a high refractive index layer application liquid and a low high refractive index layer application liquid for multiple layers to forma film including high refractive index layers and low refractive index layers; and (4) simultaneously applying, onto a substrate, and drying a high refractive index layer application liquid and a low high refractive index layer application liquid for multiple layers to form a film including high refractive index layers and low refractive index layers.

The co-extrusion step in the above-mentioned (2) can use the method described in the U.S. Pat. No. 6,049,419. More specifically, the high refractive index layer and the low refractive index layer can be formed by using a co-extrusion method from a polymer as a high refractive index layer material, metal oxide particles, and other additives (compositions for the formation of the high refractive index layer), as well as a polymer as a low refractive index layer material and other additives (compositions for the formation of the low refractive index layer).

As an embodiment, the respective refractive index layer materials can be melted at 100 to 400° C., so as to reach appropriate viscosity, and if necessary, with the addition of various types of additives, both of the polymers can be extruded through an extruder, so as to provide two alternate layers. The extruded laminated film is then solidified by cooling by means of a cooling drum or the like, whereby a laminate is obtained.

Thereafter, this laminate can be heated, and then drawn in two directions to obtain a light-reflecting film.

As the drawing method, the undrawn film obtained by detachment from the cooling drum described previously is heated within the range from the glass transition temperature (Tg) −50° C. to Tg +100° C. through a heating device such as a group of rolls and/or an infrared heater, and subjected to single-stage or multiple-stage vertical drawing in the direction of conveying the film (also referred to as a longitudinal direction). Next, the drawn film obtained in the way described above is also preferably drawn in a direction perpendicular to the direction of conveying the film (also referred to as a width direction). In order to draw the film in the width direction, it is preferable to use a tentering machine.

In the case of drawing in the direction of conveying the film or the direction perpendicular to the direction of conveying the film, the film is preferably drawn at a ratio of from 1.5 to 5.0, more preferably within the range of from 2.0 to 4.0.

In addition, thermal processing can be also conducted following the drawing. The thermal processing is preferably conducted within the range from Tg −100° C. to Tg +50° C. while conveying typically for from 0.5 to 300 seconds.

The thermal processing means is not specifically limited, but can be typically put into practice with hot air, infrared rays, heating rolls, microwaves, etc., and preferably put into practice with hot air in terms of simpleness. The heating of the film is preferably increased in a stepwise fashion.

The thermally processed film is typically cooled down to Tg or lower, and taken up with clip grasping parts cut off at both ends of the film. In addition, for the cooling, slow cooling is preferred at a cooling rate of 100° C. or lower/second, from the final thermal processing temperature to Tg.

The means for cooling is not specifically limited, but can be put into practice with conventionally known means, and in particular, it is preferable to conduct these processes while sequential cooling in plural temperature ranges, in terms of improvement in film dimensional stability. It is to be noted that the cooling rate refers to a value obtained from (T1−Tg)/t in the case of regarding the final thermal processing temperature as T1 and regarding the time for the film from the final thermal processing temperature to reaching Tg as t.

### <Light Reflector>

The light-reflecting film provided by the present invention can be applied to wide variety of fields. For example, the infrared shielding film can be applied onto equipment exposed to sunlight for a long period of time, such as outdoor sides of windows of a building and windows of a vehicle and used as a film for windows, such as an infrared shielding film for improving an infrared shielding effect.

That is, according to still another embodiment of the present invention, a light reflector including a light-permeable substrate and the above-mentioned light-reflecting film attached onto the substrate is also provided. The above-mentioned light reflector has a structure in which the light-reflecting film is joined to the light-permeable substrate via the pressure-sensitive adhesive layer.

Specific examples of the above-mentioned light-permeable substrate include glass, polycarbonate resins, polysulfone resins, acrylic resins, polyolefin resins, polyether resins, polyester resins, polyamide resins, polysulfide resins, unsaturated polyester resins, epoxy resins, melamine resins, phenolic resins, diallylphthalate resins, polyimide resins, urethane resins, polyvinyl acetate resins, polyvinyl alcohol resins, styrene resins, vinyl chloride resins and the like. Furthermore, the above-mentioned light-permeable substrate may have total light permeability, or light permeability to a partial wavelength region.

The action and effect of the present invention are exhibited further more effectively when the above-mentioned light-permeable substrate has a curved surface. “Curved surface” means a surface having a curvature radius in the range of 3 m or less. The reason why the curvature radius is preset to 3 m or less is that, if the curvature radius goes beyond 3 m, there is no difference from a planar substrate.

### EXAMPLES

The present invention will be specifically described below with reference to Examples, but is not to be considered limited by the Examples. Incidentally, an expression of “part (s)” or “%” is used in the Examples, and this expression means “part(s) by mass” or “% by mass” unless otherwise stated.

### Example 1

### [Production of Light-Reflecting Film (Infrared Ray-Shielding Film)]

### <Formation of Reflective Layer 1>

According to the melt-extrusion method described in U.S. Pat. No. 6,049,419, a polyethylene naphthalate (PEN) TN8065S (manufactured by Teijin Chemicals, Ltd.) and a polymethyl methacrylate (PMMA) resin Acripet VH (manufactured by Mitsubishi Rayon Co., Ltd.) were melted to 300° C., laminated by extrusion, drawn in the longitudinal and vertical directions by about 3-times so as to be (PMMA (152 nm)/PEN (137 nm)) 64/(PMMA (164 nm)/PEN (148 nm))64/(PMMA (177 nm)/PEN (160 nm)) 64/(PMMA (191 m)/PEN (173 nm)) 64, and then subjected to heat fixing and cooling, whereby reflective layer 1 in which 256 layers in total had been alternately laminated was obtained. Here, in the above-mentioned layer constitution, “(PMMA (152 nm)/PEN (137 nm)) 64” means that 64 units, each of which has PMMA having a film thickness of 152 nm and PEN having a film thickness of 137 nm laminated in this order, are laminated.

### <Formation of Pressure-Sensitive Adhesive Layer>

An application liquid for a pressure-sensitive adhesive layer was prepared at the following formulation.

Pressure-sensitive adhesive: N-2147 manufactured by Nippon Synthetic Chemical industry Co., Ltd. (solid content:35%) 100 parts

UV absorbing agent: Tinuvin 477 manufactured by BASF (solid content: 80%) 2.1 parts

Isocyanate-based curing agent: Coronate L55E manufactured by Nippon Polyurethane Industry Co., Ltd. (solid content: 55%) 5 parts

The above-mentioned application liquid for a pressure-sensitive adhesive layer was applied onto a silicon surface of a separator SP-PET (product name: PET-O₂-BU) (manufactured by Mitsui Chemicals Tohcello. Inc.) by means of a comma coater so as to give a dry film thickness of 10 μm, dried at 80° C. for 1 minute, the film on which the reflective layer has been formed was fed from a second paper feeder and the pressure-sensitive adhesive layer was laminated with the reflective layer, thereby the pressure-sensitive adhesive layer was formed on the reflective layer.

### <Formation of Hard Coat Layer (HC Layer)>

Beamset 577 (manufactured by Arakawa Chemical Industries, Ltd.) was used as a UV-curable resin, and methyl ethyl ketone was added as a solvent. Furthermore, 0.08% by mass of a fluorine-based surfactant (trade name: Ftergent (registered trademark) 650A, manufactured by NEOS) was added, and the total solid content was adjusted so as to be 40 parts by mass, whereby application liquid A for a hard coat layer was prepared.

The application liquid A for a hard coat layer prepared above was applied onto the outermost layer on the side opposite to the layer on which the pressure-sensitive adhesive layer had been formed, by means of a gravure coater under conditions at which a dry layer thickness of 5 ₗam was given, and dried at a drying zone temperature of 90° C. for 1 minute, and the hard coat layer was cured by using a UV lamp at an illumination in an irradiation part of 100 mW/cm² and an irradiation amount of 0.5 J/cm², whereby a hard coat layer was formed.

### A Light-Reflecting Film was Prepared as Above.

### Example 2

A light-reflecting film was produced in a similar manner, except that the application liquid for forming a hard coat layer was changed to the following application liquid B from the application liquid in Example 1.

Preparation of Application Liquid B for Hard Coat Layer

ATO (trade name: SR35M, manufactured by ANP) was used as an infrared ray-absorbing agent, Beamset 577 (manufactured by Arakawa Chemical Industries, Ltd.) was used as a UV-curable resin, and methyl ethyl ketone was added as a solvent. Furthermore, 0.08% by mass of a fluorine-based surfactant (trade name: Ftergent (registered trademark) 650A, manufactured by NEOS) was added, and preparation was conducted so that the total solid content became 40 parts by mass, and the addition amount of ATO became 55% by mass with respect to the total solid content, whereby application liquid B for a hard coat layer was prepared.

### Example 3

A light-reflecting film was prepared in a similar manner to that in Example 2, except that a film substrate was used as the substrate, and the constitutions of the high refractive index layer and the low refractive index layer were changed to the following constitutions.

### <Substrate 2>

As substrate 2, a polyethylene telephthalate film (A4300, a two-sided easy adhesive layer, thickness: 50 μm, length 200 m×width 210 mm, manufactured by Toyobo Co. Ltd.) was prepared.

### <Formation of Reflective Layer 2>

### <<Application Liquid for Low Refractive Index Layer>>

Firstly, an application liquid for a low refractive index layer was prepared. Specifically, 430 parts of a colloidal silica (10% by mass) (Snowtex OXS; manufactured by Nissan Chemical Industries, Ltd.), 150 parts of an aqueous boric acid solution (3% by mass), 85 parts of water, 300 parts of polyvinyl alcohol (4% by mass) (JP-45; polymerization degree: 4,500; saponification degree: 88 mol %; manufactured by Japan VAM & POVAL Co., Ltd.), 3 parts of a surfactant (5% by mass) (Softazolin LSB-R; manufactured by Kawaken Fine Chemicals Co., Ltd.) were added at 45° C. in this order. Furthermore, these were formed into 1,000 parts with pure water, whereby an application liquid for a low refractive index layer was prepared.

### <<Application Liquid for High Refractive Index Layer>>

Secondly, an application liquid for a high refractive index layer was prepared. Specifically, a dispersion liquid of silica-modified titanium oxide particles was prepared in advance, and a solvent and the like were added to this dispersion liquid.

The dispersion liquid of silica-modified titanium oxide particles was prepared as follows.

An aqueous titanium sulfate solution was subjected to heat ray-shielding hydrolysis by a known technique to give titanium oxide hydrate. The obtained titanium oxide hydrate was suspended in water to give 10 L of an aqueous suspension liquid (TiO₂ concentration: 100 g/L). To this was added 30 L of an aqueous sodium hydroxide solution (concentration: 10 mol/L) under stirring, the temperature was raised to 90° C., and aging was conducted for 5 hours. The obtained solution was neutralized with hydrochloric acid, filtered and washed with water, whereby a base-treated titanium compound was obtained.

The base-treated titanium compound was then suspended in pure water so that the TiO₂ concentration became 20 g/L, and stirred. Under stirring, citric acid in an amount of 0.4 mol % with respect to the TiO₂ amount was added. The temperature was raised to 95° C., concentrated hydrochloric acid was added thereto so that the hydrochloric acid concentration became 30 g/L, and stirring was conducted for 3 hours with keeping the liquid temperature. When the pH and zeta potential of the obtained mixed liquid were measured, the pH was 1.4, and the zeta potential was +40 mV. Furthermore, when the particle diameter was measured by a Zetasizer Nano (manufactured by Malvern), the volume average particle diameter was 35 nm, and the degree of monodispersion was 16%.

To 1 kg of a 20.0% by mass titanium oxide sol water-based dispersion liquid containing rutile-type titanium oxide particles was added 1 kg of pure water to prepare a 10.0% by mass titanium oxide sol water-based dispersion liquid.

To 0.5 kg of the above-mentioned 10.0% by mass titanium oxide sol water-based dispersion liquid was added 2 kg of pure water, and the mixture was heated to 90° C. Thereafter, 1.3 kg of an aqueous silicic acid solution having an SiO₂ concentration of 2.0% by mass was gradually added. The obtained dispersion liquid was subjected to a heating treatment in an autoclave at 175° C. for 18 hours and further concentrated, whereby a dispersion liquid of 20% by mass of silica-modified titanium oxide particles containing SiO₂-coated titanium oxide having a rutile-type structure (a sol water dispersion liquid) was obtained.

A solvent and the like were added to the thus-prepared sol water dispersion liquid of silica-modified titanium oxide particles to prepare an application liquid for a high refractive index layer. Specifically, 300 parts of the sol water dispersion liquid of silica-modified titanium oxide particles (20.0% by mass), 100 parts of an aqueous citric acid solution (1.92% by mass), 20 parts of a polyvinyl alcohol (10% by mass) (PVA-103, polymerization degree: 300, saponification degree: 99 mol %, manufactured by Kuraray Co., Ltd.), 100 parts of an aqueous boric acid solution (3% by mass), 350 parts of a polyvinyl alcohol (4% by mass) (PVA-124, polymerization degree: 2,400, saponification degree: 88 mol %, manufactured by Kuraray Co., Ltd.) and 1 part of a surfactant (5% by mass) (Softazoline LSB-R, manufactured by Kawaken Fine Chemicals Co., Ltd.) were added at 45° C. in this order. Furthermore, these were formed into 1,000 parts with pure water, whereby an application liquid for a high refractive index layer was prepared.

### <<Application and Drying>>

Using a slide hopper application apparatus capable of multi-layer application of 20 layers, the application liquid for a low refractive index layer and the application liquid for a high refractive index layer were subjected to multi-layer application of 21 layers onto a substrate 2 heated to 45° C., while keeping the temperatures of the application liquids at 45° C. At this time, the lowermost layer and the uppermost layer were set as low refractive index layers, and the other layers were set so that the respective low refractive index layers and high refractive index layers were alternately laminated. The application amounts were adjusted so that the dry film thicknesses became 150 nm for each low refractive index layer and 130 nm for each high refractive index layer. The above-mentioned film thicknesses were each confirmed by cutting the produced light-reflecting film, and observing the cross-sectional surface thereof by an electron microscope. At this time, in the case when the interface between the two layers was not able to be clearly observed, the interface was determined by an XPS profile of the TiO₂ contained in the layer in the thickness direction, which was obtained by an XPS surface analyzer.

At immediately after the application, the layers were set by blowing with cold air of 5° C. At this time, when the surface was touched by a finger, the time until the finger came out clean (set time) was 5 minutes.

After the set was completed, the layers were dried by blowing with hot air of 80° C., whereby a multi-layer application product formed of 20 layers was prepared.

### Example 4

A light-reflecting film was prepared in a similar manner, except that the irradiation amount of the hard coat layer was changed to 3 J/cm² from that in Example 3, and the curing agent for the pressure-sensitive adhesive layer application liquid was changed from 5 parts to 7 parts.

### Example 5

A light-reflecting film was prepared in a similar manner, except that the pressure-sensitive adhesive layer was changed from that in Example 3 according to the following description.

Pressure-sensitive adhesive: OC-8962K manufactured by Saiden Chemical Industry Co., Ltd. (solid content: 35%) 100 parts

UV absorbing agent: Tinuvin 477 manufactured by BASF (solid content: 80%) 2.1 parts

Silane coupling agent: KBM-403 manufactured by Shin-Etsu Chemical Co., Ltd. (solid content: 100%) 0.09 part

Isocyanate-based curing agent: Coronate L55E manufactured by Nippon Polyurethane Industry Co., Ltd. (solid content: 55%) 0.5 part

### Example 6

Preparation was conducted in a similar manner, except that the pressure-sensitive adhesive layer was changed from that in Example 3 according to the following description.

Pressure-sensitive adhesive: TPO-3232 manufactured by Saiden Chemical Industry Co., Ltd. (solid content: 35%) 100 parts

UV absorbing agent: Tinuvin 477 manufactured by BASF (solid content: 80%) 2.1 parts

Isocyanate-based curing agent: Coronate L55E manufactured by Nippon Polyurethane Industry Co., Ltd. (solid content: 55%) 0.5 part

### Comparative Example 1

Preparation was conducted in a similar manner, except that the pressure-sensitive adhesive layer was changed from that in Example 1 according to the following description.

N-2147 (an acrylic-based pressure-sensitive adhesive) 100 parts (concentration: 35%)

Ethyl acetate 121.6 parts

T-477 (triazine-based UV absorbing agent) 3.15 parts (concentration: 80%)

KBM403 (silane coupling agent) 0.90 part (concentration: 10%)

Coronate L55E (trylenediisocyanate) 5 parts (concentration: 55%)

### Comparative Example 2

A light-reflecting film was prepared in a similar manner, except that the pressure-sensitive adhesive layer was changed from that in Example 3 according to the following description.

### Comparative Example 3

A light-reflecting film was prepared by disposing the near infrared ray-absorbing layer described in JP 2007-232931 A on a PET, and preparing the pressure-sensitive adhesive layer of Example 1 on the opposite side.

### (Measurement of Elastic Modulus)

Each of the application liquid for a hard coat layer and the application liquid for a pressure-sensitive adhesive layer was singly applied onto a glass substrate to prepare respective samples with a dry film thickness of 2 μm, and a measurement was conducted by a nanoindentation process (an apparatus in which a TriboScope, manufactured by HYSITRON, is attached to a scanning probe microscope SPI3800N, manufactured by Seiko Instruments Inc., indenter: 90° Cube corner tip, maximum load: 20 μN). An average value of the measured values was obtained with setting the number of measurement to n=3 and the unit of the elastic modulus to Pa. The result is shown in the following Table 1.

### (Measurement of Pressure-Sensitive Adhesive Force)

The pressure-sensitive adhesive force was measured based on JIS A5759 6. 8. 1. A light-reflecting film having a rectangular shape (width 25 mm×length 30 cm) was disposed on a float sheet glass that had been washed with water and degreased with an alcohol, and pressurized by using a pressure roller by reciprocating the pressure roller at a velocity of 300 mm/min. The sample was subjected to a 180° peeling test by using a tensile tester (manufactured by Toyo Seiki Co., Ltd.), whereby a pressure-sensitive adhesive force (an instantaneous pressure-sensitive adhesive force) was obtained. The result is shown in the following Table 1.

### [Evaluation Items]

### <Infrared Transmittance>

Using a spectrometer (an integrating sphere was used, manufactured by Hitachi, Ltd., type U-4000), the infrared transmittance (800 to 1,300 nm) in the region of from 300 nm to 2,000 nm in each infrared ray-shielding film sample was measured. The result is shown in the following Table 1.

### <Curved Surface Workability>

The prepared light-reflecting film was attached with water to a curved surface glass (curvature radius: 3 m or less), and the appearance was evaluated according to the following evaluation criteria. The result is shown in the following Table 1.

◯: The light-reflecting film was able to be attached finely with no problem

Δ: Wrinkles were seen on a part of the end parts

×: Wrinkles were seen on several positions

### <Curved Surface Tight Adhesiveness>

The prepared light-reflecting film was attached with water to a curved surface glass (curvature radius: 3 m or less), left under conditions of 25° C. and 50% RH for 3 months, and the tight adhesiveness and the appearance at after 3 months were evaluated under conditions of 23° C. and 50% RH according to the following evaluation criteria. The results are shown in the following Table 1.

◯: No problem

Δ: A part of the end parts was lifted

×: Peeling was seen on the end parts

### <Evaluation of Adhesive Residue>

The prepared light-reflecting film was attached with water to a curved surface glass (curvature radius: 3 m or less) and left under conditions of 25° C. and 50% RH for 7 days, a tensile test was conducted under conditions of 23° C. and 50% RH (manufactured by Toyo Seiki Co., Ltd.), and the pressure-sensitive adhesive force was evaluated according to the following evaluation criteria. The results are shown in the following Table 1.

◯: The pressure-sensitive adhesive force was 2 N or more, and no adhesive residue was seen

Δ: The pressure-sensitive adhesive force was 2 N or more, and the adhesive slightly remained

×: The pressure-sensitive adhesive force was lower than 2 N, and the adhesive remained on the whole surface.

### <Durability>

Using a sunshine weather meter defined in JISB7753 (S80 manufactured by Suga Test Instruments Co., Ltd.), the tight adhesiveness after 3,000 hours under conditions of 63° C. measured by a black panel thermometer, a relative humidity of 50%, and 1 cycle for 2 hours and rainfall for 18 minutes in 1 cycle was evaluated according to the following evaluation criteria.

◯: No problem

Δ: A part of the end parts was lifted

×: Peeling was seen on the end parts

TABLE 1

| | | | | | Elastic modulus | |
|---|---|---|---|---|---|---|
| | | | | | of HC layer/ | Instantaneous |
| | | | | | elastic modulus | pressure- |
| | High | Low | Pressure- | | of pressure- | sensitive |
| | refractive | refractive | sensitive | | sensitive | adhesive force |
| | index layer | index layer | adhesive layer | HC layer | adhesive layer | (N/25 mm) |
| Example 1 | PMMA | PEN | N-2147 | | 4 | 4.5 |
| Example 2 | PMMA | PEN | N-2147 | ATO | 5 | 4.5 |
| | | | | particles | | |
| Example 3 | PVA + TiO₂ | PVA + SiO₂ | N-2147 | ATO | 5 | 4.5 |
| | | | | particles | | |
| Example 4 | PVA + TiO₂ | PVA + SiO₂ | N-2147 | ATO | 5 | 4.5 |
| | | | | particles | | |
| Example 5 | PVA + TiO₂ | PVA + SiO₂ | OC-8962K | ATO | 3.5 | 2.5 |
| | | | | particles | | |
| Example 6 | PVA + TiO₂ | PVA + SiO₂ | TPO-3232 | ATO | 6 | 7.5 |
| | | | | particles | | |
| Comparative | PMMA | PEN | N-2147 | | 2.5 | 9 |
| Example 1 | | | | | | |
| Comparative | PVA + TiO₂ | PVA + SiO₂ | N-2147 | ATO | 5 | 9 |
| Example 2 | | | | particles | | |

| | | | | |
|---|---|---|---|---|
| Comparative | Film containing Infrared | N-2147 | 2.5 | 4.5 |
| Example 3 | absorbing agent | | | |

| | Pressure- | Results of evaluation | | | | |
|---|---|---|---|---|---|---|
| | sensitive | | | Tight | | |
| | adhesive force | Infrared ray | Curved | adhesiveness | | |
| | over time | transmittance | surface | on curved | Adhesive | |
| | (N/25 mm) | (%) | workability | surface | residue | Durability |
| Example 1 | 8 | 17 | ∘ | ∘ | ∘ | Δ |
| Example 2 | 8 | 13 | ∘ | ∘ | ∘ | Δ |
| Example 3 | 8 | 15 | ∘ | ∘ | ∘ | Δ |
| Example 4 | 11 | 15 | ∘ | ∘ | ∘ | ∘ |
| Example 5 | 5 | 15 | ∘ | Δ | ∘ | Δ |
| Example 6 | 12 | 15 | ∘ | ∘ | ∘ | ∘ |
| Comparative | 15 | 12 | Δ | x | ∘ | x |
| Example 1 | | | | | | |
| Comparative | 15 | 14 | x | Δ | Δ | x |
| Example 2 | | | | | | |
| Comparative | 8 | 25 | Δ | Δ | ∘ | Δ |
| Example 3 | | | | | | |

It can be understood from the results shown in Table 1 that, according to the present invention, a light-reflecting film that, while ensuring tight adhesiveness to an adherend having a curved surface, leaves little adhesive residue when peeled from an adherend for the purposes of re-attaching, can be re-attached, and is excellent in durability and heat ray-shielding conductance can be provided.

The present application is based on the Japanese Patent Application No. 2013-261319 filed on Dec. 18, 2013, and the disclosed contents thereof are herein incorporated by reference.

### REFERENCE SIGNS LIST

1, 1′ light-reflecting film

11 substrate

12 primer layer

13 reflective layer

14 low refractive index layer

15 high refractive index layer

16 hard coat layer

17 transparent adhesive layer

18 substrate

L solar light

1. A light-reflecting film comprising:
a reflective layer having at least one or more laminate(s) in which a high refractive index layer containing a polymer and a low refractive index layer containing a polymer are laminated;
a pressure-sensitive adhesive layer that is disposed on one outermost layer; and
a hard coat layer that is disposed on another outermost layer,
wherein the elastic modulus of the pressure-sensitive adhesive layer and the elastic modulus of the hard coat layer satisfy the following Formula (1):
the elastic modulus of the hard coat layer [Pa]/the elastic modulus of the pressure-sensitive adhesive layer [Pa]≧3 and
the instantaneous pressure-sensitive adhesive force exhibited when the pressure-sensitive adhesive layer is applied to glass is from 2 to 8 N/25 mm.

2. The light-reflecting film according to claim 1, wherein the instantaneous pressure-sensitive adhesive force exhibited when the pressure-sensitive adhesive layer is applied to the glass is from 4 to 8 N/25 mm, and
the pressure-sensitive adhesive force over time when the pressure-sensitive adhesive layer and the glass are left with keeping the attached state under conditions of 30° C. and a humidity of 60% RH for 1 week is from 7 to 15 N/25 mm.

3. The light-reflecting film according to claim 2, wherein the pressure-sensitive adhesive force over time is from 10 to 15 N/25 mm.

4. The light-reflecting film according to claim 1, wherein the polymer contained in the high refractive index layer and the low refractive index layer contains at least one kind selected from the group consisting of polyesters, polycarbonates and poly(meth)acrylates.

5. The light-reflecting film according to claim 1, wherein the polymer contained in the high refractive index layer and the low refractive index layer contains at least one kind of polyvinyl alcohol-based resins.

6. The light-reflecting film according to claim 1, which contains heat ray-shielding microparticles.

7. A light reflector comprising a light-permeable substrate, and the light-reflecting film according to claim 1 attached to the light-permeable substrate.

8. The light reflector according to claim 7, wherein the light-permeable substrate has a curved surface.

9. The light-reflecting film according to claim 2, wherein the polymer contained in the high refractive index layer and the low refractive index layer contains at least one kind selected from the group consisting of polyesters, polycarbonates and poly(meth)acrylates.

10. The light-reflecting film according to claim 2, wherein the polymer contained in the high refractive index layer and the low refractive index layer contains at least one kind of polyvinyl alcohol-based resins.

11. The light-reflecting film according to claim 2, which contains heat ray-shielding microparticles.

12. A light reflector comprising a light-permeable substrate, and the light-reflecting film according to claim 2 attached to the light-permeable substrate.

13. The light-reflecting film according to claim 3, wherein the polymer contained in the high refractive index layer and the low refractive index layer contains at least one kind selected from the group consisting of polyesters, polycarbonates and poly(meth)acrylates.

14. The light-reflecting film according to claim 3, wherein the polymer contained in the high refractive index layer and the low refractive index layer contains at least one kind of polyvinyl alcohol-based resins.

15. The light-reflecting film according to claim 3, which contains heat ray-shielding microparticles.

16. A light reflector comprising a light-permeable substrate, and the light-reflecting film according to claim 3 attached to the light-permeable substrate.

17. The light-reflecting film according to claim 4, wherein the polymer contained in the high refractive index layer and the low refractive index layer contains at least one kind of polyvinyl alcohol-based resins.

18. The light-reflecting film according to claim 4, which contains heat ray-shielding microparticles.

19. A light reflector comprising a light-permeable substrate, and the light-reflecting film according to claim 4 attached to the light-permeable substrate.

20. The light-reflecting film according to claim 5, which contains heat ray-shielding microparticles.
